(19) United States
(12) Patent Application Publication
(10) Pub. No.: US 2026/0025698 A1
(43) Pub. Date: Jan. 22, 2026

(54) BEAM PREDICTION METHOD, APPARATUS, DEVICE, AND STORAGE MEDIUM

(71) Applicant: VIVO MOBILE COMMUNICATION CO., LTD., Dongguan (CN)

(72) Inventors: Tong ZHOU, Dongguan (CN); Peng SUN, Dongguan (CN); Hao WU, Dongguan (CN); Yuan SHI, Dongguan (CN)

(73) Assignee: VIVO MOBILE COMMUNICATION CO., LTD., Dongguan (CN)

(21) Appl. No.: 19/340,840

(22) Filed: Sep. 25, 2025

Related U.S. Application Data
(63) Continuation of application No. PCT/CN2024/084312, filed on Mar. 28, 2024.

(30) Foreign Application Priority Data
Apr. 3, 2023 (CN) 202310352492.X

(51) Int. Cl. H04W 24/10; H04W 24/08

(52) U.S. Cl. CPC H04W 24/10; H04W 24/08

(57) ABSTRACT

A beam prediction method, an apparatus, a device, and a storage medium, are provided. The beam prediction method, performed by a first device, includes: receiving a target list sent by a second device, where the target list includes virtual identifiers used for indicating related information of beams for prediction. The first device obtains a beam prediction result of the beam for prediction based on at least one beam measurement result and the target list.

### CROSS-REFERENCE TO RELATED APPLICATIONS

This application is a continuation of International Application No. PCT/CN2024/084312, filed Mar. 28, 2024, which claims priority to Chinese Patent Application No. 202310352492.X, filed Apr. 3, 2023. The entire contents of each of the above-referenced applications are expressly incorporated herein by reference.

### TECHNICAL FIELD

This application belongs to the field of communication technologies, and specifically, to a beam prediction method, an apparatus, a device, and a storage medium.

### BACKGROUND

With the development of wireless technologies, a beam-based wireless communication technology is widely used. For example, both uplink transmission and downlink transmission between a base station and a terminal may be implemented based on beams, thereby improving transmission quality.

Beam prediction may be performed during beam-based transmission, to further improve transmission quality. In addition, during the beam prediction, if beam related information (for example, a beam direction and a 3 dB bandwidth of the beam) sent by the base station can be obtained when the beam prediction is performed on the terminal side, prediction accuracy can be effectively improved. Similarly, if beam related information of received by the terminal can be obtained when the beam prediction is performed on the base station side, effectiveness of the beam prediction can also be improved. However, the beam information is usually sensitive information related to product implementation of a device, and directly exposing the beam information to a peer end carries a risk of private information exposure.

### SUMMARY

Embodiments of this application provide a beam prediction method, an apparatus, a device, and a storage medium.

According to a first aspect, a beam prediction method is provided, including:

A first device receives a target list sent by a second device, where the target list includes virtual identifiers used for indicating related information of beams for prediction.

The first device obtains a beam prediction result of the beam for prediction based on at least one beam measurement result and the target list.

According to a second aspect, a beam prediction method is provided, including:

A second device sends a target list to a first device, where the target list includes virtual identifiers used for indicating related information of beams for prediction.

According to a third aspect, a beam prediction apparatus is provided, including:
a first receiving module, configured to receive a target list sent by a second device, where the target list includes virtual identifiers used for indicating related information of beams for prediction; and
a first processing module, configured to obtain a beam prediction result of the beam for prediction based on at least one beam measurement result and the target list.

According to a fourth aspect, a beam prediction apparatus is provided, including:
a first sending module, configured to send a target list to a first device, where the target list includes virtual identifiers used for indicating related information of beams for prediction.

According to a fifth aspect, a communication device is provided, including a processor and a memory, where a program or instructions executable on the processor are stored in the memory; and when the program or the instructions are executed by the processor, the steps of the method according to the first aspect or the second aspect are implemented.

According to a sixth aspect, a beam prediction system is provided, including: a first device and a second device, where the first device may be configured to perform the steps of the beam prediction method according to the first aspect, and the second device may be configured to perform the steps of the beam prediction method according to the second aspect.

According to a seventh aspect, a readable storage medium is provided. The readable storage medium stores a program or an instruction. The program or the instruction, when executed by a processor, implement the steps of the method according to the first aspect or implement the steps of the method according to the second aspect.

According to an eighth aspect, a chip is provided. The chip includes a processor and a communication interface. The communication interface is coupled to the processor, and the processor is configured to run a program or instructions, to implement the method according to the first aspect or implement the method according to the second aspect.

According to a ninth aspect, a computer program/program product is provided. The computer program/program product is stored in a storage medium, and the computer program/program product is executed by at least one processor to implement the steps of the method according to the first aspect or the second aspect.

According to a tenth aspect, an embodiment of this application provides a beam prediction apparatus. The apparatus is configured to perform the steps of the beam prediction method according to the first aspect or the second aspect.

### BRIEF DESCRIPTION OF THE DRAWINGS

FIG. 1 is a block diagram of an applicable wireless communication system according to an embodiment of this application;

FIG. 2 is a flowchart of a beam prediction method according to an embodiment of this application;

FIG. 3 is a first diagram of beam prediction results of predicting beams for prediction by AI models according to an embodiment of this application;

FIG. 4 is a second diagram of beam prediction results of predicting beams for prediction by AI models according to an embodiment of this application;

FIG. 5 is a flowchart of another beam prediction method according to an embodiment of this application;

FIG. 6 is a flowchart of an implementation for a beam prediction method according to an embodiment of this application;

FIG. 7 is a flowchart of another implementation for a beam prediction method according to an embodiment of this application;

FIG. 8 is a block diagram of a structure of a beam prediction apparatus according to an embodiment of this application;

FIG. 9 is a block diagram of a structure of another beam prediction apparatus according to an embodiment of this application;

FIG. 10 is a block diagram of a structure of a communication device according to an embodiment of this application;

FIG. 11 is a block diagram of a structure of a terminal according to an embodiment of this application; and

FIG. 12 is a block diagram of a structure of a network side device according to an embodiment of this application.

### DETAILED DESCRIPTION

The technical solutions in embodiments of this application are clearly described in the following with reference to the accompanying drawings in embodiments of this application. It is clear that the described embodiments are merely a part rather than all of embodiments of this application. All other embodiments obtained by a person of ordinary skills in the art based on embodiments of this application fall within the protection scope of this application.

In this application, the terms “first,” “second,” and the like are used to distinguish similar objects, but are not used to describe a specific sequence or order. It should be understood that the terms used in this way are exchangeable in a proper case, so that embodiments of this application can be implemented in a sequence other than those illustrated or described herein. In addition, objects distinguished using “first” and “second” are usually of one type, and a quantity of the objects is not limited. For example, one or more first objects may be arranged. In addition, “or” in this application indicates at least one of connected objects. For example, “A or B” covers three solutions, namely, a solution 1: A is included and B is not included; a solution 2: B is included and A is not included; and a solution 3: both A and B are included. The character “/” in this specification usually indicates an “or” relationship between the associated objects.

The term “indication” in this application may be either a direct indication (or an explicit indication) or an indirect indication (or an implicit indication). The direct indication may be understood as that a sending party informs a receiving party of content such as specific information, a specific operation needing to be performed, or a specific request result in the sent indication. The indirect indication may be understood as that a receiving party determines corresponding information or performs determining based on the indication sent by a sending party, and determines an operation needing to be performed, a request result, or the like based on a determining result.

It should be noted that, the technology described in embodiments of this application is applicable to a Long Term Evolution (LTE)/LTE-Advanced (LTE-A) system, and may be further applied to another wireless communication system, such as a Code Division Multiple Access (CDMA) system, a Time Division Multiple Access (TDMA) system, a Frequency Division Multiple Access (FDMA) system, an Orthogonal Frequency Division Multiple Access (OFDMA) system, a Single-Carrier Frequency Division Multiple Access (SC-FDMA) system, or another system. Terms “system” and “network” in embodiments of this application are usually interchangeably used, and the described technology is applicable to both the system and the radio technology mentioned above, or is applicable to another system and radio technology. A New Radio (NR) system is described below as an example, and the term NR is used in most of the following description. Nevertheless, the technologies are also applicable to a system other than the NR system, such as a 6th Generation (6G) communication system.

FIG. 1 is a block diagram of an applicable wireless communication system according to an embodiment of this application. The wireless communication system includes terminals 11 and a network side device 12. The terminal 11 may be a terminal side device such as a mobile phone, a tablet computer, a laptop computer, a notebook computer, a Personal Digital Assistant (PDA), a palmtop computer, a netbook, an Ultra-Mobile Personal Computer (UMPC), a Mobile Internet Device (MID), an Augmented Reality (AR) device, a Virtual Reality (VR) device, a robot, a wearable device, a flight vehicle, a Vehicle User Equipment (VUE), an on-board device, a Pedestrian User Equipment (PUE), a smart home appliance (a home device with a wireless communication function, such as a refrigerator, a television, a washing machine, or furniture), a game console, a personal computer, a teller machine, or a self-service machine. The wearable device includes: a smart watch, a smart band, a smart headset, smart glasses, smart jewelry (a smart bangle, a smart bracelet, a smart ring, a smart necklace, a smart anklet bangle, a smart anklet, and the like), a smart wristband, smart clothing, and the like. The vehicle-mounted device may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in embodiments of this application.

The network side device 12 may include an access network device or a core network device. The access network device may also be referred to as a Radio Access Network (RAN) device, a radio access network function, or a radio access network unit. The access network device may include a base station, a Wireless Local Area Network (WLAN) Access Point (AS), a Wireless Fidelity (WiFi) node, and the like. The base station may be referred to as a NodeB (NB), an Evolved NodeB (eNB), a next generation NodeB (gNB), a New Radio NodeB (NR NodeB), an access point, a Relay Base Station (RBS), a Serving Base Station (SBS), a Base Transceiver Station (BTS), a radio base station, a radio transceiver, a Basic Service Set (BSS), an Extended Service Set (ESS), a Home NodeB (HNB), a home evolved NodeB, a Transmission Reception Point (TRP), or another appropriate term in the field, as long as the same technical effect is achieved. The base station is not limited to a specific technical word. It should be noted that, in embodiments of this application, introduction is made only taking the base station in the NR system as an example, and a specific type of the base station is not limited.

A beam prediction method provided in embodiments of this application is described in detail below with reference to the accompanying drawings by using some embodiments and application scenarios thereof.

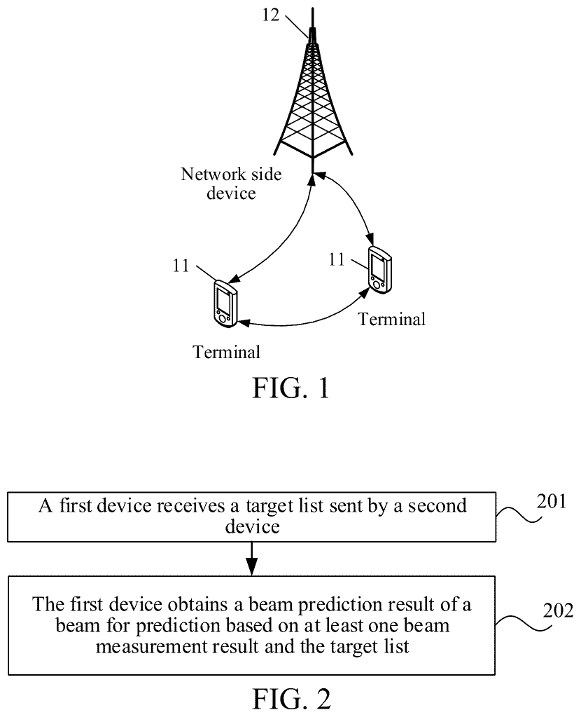

According to a first aspect, FIG. 2 is a flowchart of a beam prediction method according to an embodiment of this application. The method may include the following steps 201 and 202.

Step 201: A first device receives a target list sent by a second device.

The target list includes virtual identifiers used for indicating related information of beams for prediction. In other words, the virtual identifiers may be understood as information obtained by processing the related information of the beams for prediction by using a target processing method. To be specific, the first device communicating with the second device may obtain, based on the virtual identifiers, the beam related information indicated by the virtual identifiers, but another device other than the second device or another device other than predetermined multiple devices cannot obtain, even if obtaining the virtual identifiers, the beam related information indicated by the virtual identifiers. In some implementations, the virtual identifiers are obtained by mapping first information by using the target processing method, and the first information includes beam related information of the second device. For example, the second device may map the first information by using the target processing method to obtain virtual identifiers, thereby using a part or all of the obtained virtual identifiers as the virtual identifiers of the beams for prediction. (In other words, a part or all of beams corresponding to the first information may be used as the beams for prediction).

The target processing method maybe described as a mapping processing method, a privacy processing method, or the like. This is not limited in this embodiment of this application. In addition, the target processing method may be performing mapping processing, to be specific, mapping one piece of data to one or more pieces of data. In some implementations, the target processing method may be performing encryption processing, to be specific, performing encryption processing on one piece of data to obtain encrypted data. A specific implementation of the target processing method is not limited in this embodiment.

In some implementations, the related information of the beam may include at least one of:
a beam direction;
a 3 dB bandwidth of the beam;
a beam gain;
an antenna radiation pattern; and
an antenna configuration parameter.

In addition, the virtual identifiers included in the target list may be obtained by mapping related information of a target quantity of beams of the second device. The beam may be a transmit beam, a receive beam, or a beam pair. The target quantity of beams may include all beams of the second device, or the target quantity is determined by at least one of a protocol agreement, a network side configuration, or an indication of the first device, or is determined by the second device.

In some implementations, before step 201 “a first device receives a target list sent by a second device”, the method further includes:

The first device sends request information to the second device, where the request information is used by the first device to request the second device for the target list.

It can be learned that the first device may further send the request information to the second device, to trigger the second device to send the target list to the first device.

Step 202: The first device obtains a beam prediction result of the beam for prediction based on at least one beam measurement result and the target list.

The at least one beam measurement result includes at least one of:
reference signal received power (Reference Signal Received Power, RSRP);
reference signal receiving quality (Reference Signal Receiving Quality, RSRQ);
a signal-to-noise and interference ratio (Signal-to-noise and Interference Ratio, SINR); and
a wireless channel.

The beam prediction result may include at least one of:
beam quality information (for example, RSRP, RSRQ, or a SNIR);
an identifier of a beam with strongest beam quality;
probability distribution of identifiers of beams with strongest beam quality; and
a confidence level.

In some implementations, that the first device obtains the at least one beam measurement result includes:

The first device performs beam measurement, to obtain the at least one beam measurement result.

In some implementations,
the first device receives the at least one beam measurement result sent by the second device.

For example, when the first device is a terminal and the second device is a network side device, the first device may perform beam measurement, to obtain the at least one beam measurement result. When the first device is a network side device and the second device is a terminal, the first device needs to obtain the at least one beam measurement result from the second device.

In this embodiment of this application, the first device may be a terminal and the second device may be a network side device (for example, a base station), or the first device may be a network side device and the second device may be a terminal.

When the first device is a terminal and the second device is a network side device, the network side device may send, to the terminal, a virtual identifier used for indicating related information of a transmit beam for prediction of the network side device, and the terminal may obtain a beam prediction result of the transmit beam for prediction based on a beam measurement result of the transmit beam of the network side device measured by the terminal and the virtual identifier.

When the first device is a network side device and the second device is a terminal, the terminal may send, to the network side device, a virtual identifier used for indicating related information of a receive beam for prediction of the terminal, and the network side device may obtain a beam prediction result of the receive beam for prediction based on a beam measurement result of a beam (which may include at least one of a transmit beam, a receive beam, or a beam pair) measured by the terminal and the virtual identifier.

It may be learned from steps 201 and 202 that, in this embodiment of this application, the first device can receive the target list sent by the second device, to obtain the beam prediction result of the beam for prediction based on the at least one beam measurement result and the target list. The target list includes the virtual identifiers used for indicating the related information of the beams for prediction. It may be learned that, in this embodiment of this application, the virtual identifiers used for indicating the related information of the beams for prediction instead of the related information of the beams for prediction is directly transmitted between the first device and the second device. In this way, the beam measurement result and the virtual identifiers used for indicating the related information of the beams for prediction can be combined to implement more accurate beam prediction without exposing sensitive information of the beam. Therefore, the beam prediction method in this embodiment of this application resolves a problem of exposing the sensitive information of the beam.

In some implementations, step 202 “the first device obtains a beam prediction result of the beam for prediction based on at least one beam measurement result and the target list” includes the following steps A-1 and A-2.

Step A-1: The first device obtains a target association relationship, where the target association relationship includes at least one of a first association relationship and a second association relationship, the first association relationship includes an association relationship between the beam measurement result and a virtual identifier, and the second association relationship includes an association relationship between a measurement resource used for beam measurement and a virtual identifier.

Step A-2: The first device obtains the beam prediction result of the beam for prediction by using an artificial intelligence AI unit based on the beam measurement result, the target association relationship, and the target list.

In a mobile communication system, there is an increasing quantity of use cases that start to incorporate Artificial Intelligence (AI). For example, there are AI-based Channel State Information (CSI) feedback compression, AI-based beam management, AI-based positioning, AI-based energy saving, AI-based load balancing, and the like at a physical layer. In this embodiment of this application, the AI unit may be used to perform beam prediction.

The AI unit in this embodiment of this application may also be referred to as an AI model, an AI structure, or the like, or the AI unit may also be a processing unit that can implement a particular AI-related algorithm, formula, processing procedure, capability, or the like, or the AI unit may be a processing method, an algorithm, a function, a module, or a unit for a particular data set, or the AI unit may be a processing method, an algorithm, a function, a module, or a unit that runs on AI-related hardware such as a Graphics Processing Unit (GPU), a Neural Network Processing Unit (NPU), a Tensor Processing Unit (TPU), or an Application-Specific Integrated Circuit (ASIC). This is not specifically limited in this application. In some implementations, the particular data set includes at least one of an input and an output of the AI unit.

In this embodiment of this application, the first device is a device that performs beam prediction. The first device may be a terminal, or may be a network side device (for example, a base station). In other words, the terminal may predict a transmit beam or a receive/transmit beam pair of the network side device, or the network side device may predict a receive/transmit beam pair or a receive beam of the terminal. Therefore, the AI unit may be disposed on the terminal or the network side device.

In step A-2, the first device determines input data of the AI model based on the beam measurement result, the target association relationship, and the target list, to input the determined input data into the AI model, so that the beam prediction result of the beam for prediction can be obtained through inference (corresponding to step E-1 described below). In some implementations, in step A-2, the first device may input the beam measurement result and the target association relationship into the AI model, and then may obtain the beam prediction result of the beam for prediction with reference to an output result of the AI model and the target list (corresponding to step E-2 described below). That is, in this embodiment of this application, “the beam measurement result, the target association relationship, and the target list” are used for determining at least some input data of the AI unit.

In some implementations, the method further includes the following step B-1.

Step B-1: The first device generates, during training of the AI unit, a data set based on the virtual identifiers of the beams for prediction, the beam measurement result, and third target information, and associates the data set with a target identifier, where the third target information includes a virtual identifier corresponding to the beam measurement result or a virtual identifier corresponding to the measurement resource.

After the first device generates the data set, the first device or another device other than the first device may train the AI unit based on the data set.

In addition, in this embodiment of this application, the target identifier is used for indicating a target processing method (that is, a mapping method) for generating the virtual identifier, and the data set of the AI unit also includes the virtual identifier. Therefore, if the data set of the AI unit is associated with the target identifier, the mapping method for the virtual identifier used when the data set is generated can be learned based on the target identifier associated with the data set.

In some implementations, the method further includes the following step C-1.

Step C-1: The first device determines a target identifier.

The target identifier is used for indicating a target processing method, the virtual identifiers are obtained by mapping first information by using the target processing method, and the first information includes beam related information of the second device.

The AI unit is associated with the target identifier.

In addition, the target identifier determined by the first device may be sent by the second device, or may be agreed on by a protocol, or may be configured on a network side.

Moreover, the mapping method for the virtual identifier included in the data set of the AI unit and a mapping method for the virtual identifiers of the beams for prediction included in the target list should be the same; otherwise, the AI unit cannot obtain an effective prediction result. Therefore, in this embodiment of this application (that is, in step A-2), the AI unit used for performing beam prediction needs to match the target identifier used for indicating the mapping method for the virtual identifier included in the target list.

It should be further noted that the target identifier may be associated with an identifier of the data set or an identifier of the AI unit. Therefore, the target identifier may also be implicitly indicated by using the identifier of the data set or the identifier of the AI unit.

In some implementations, the identifier of the AI unit may be an identifier of an AI model, an identifier of an AI structure, an identifier of an AI algorithm, or an identifier of a particular data set associated with the AI unit, or an identifier of a particular AI-related scenario, environment, channel characteristic, or device, or an identifier of an AI-related function, feature, capability, or module. This is not specifically limited in this application.

In some implementations, that the first device obtains a target association relationship includes step D-1 and step D-2 or step D-3.

Step D-1: The first device receives the second association relationship sent by the second device.

Step D-2: The first device obtains the first association relationship based on the second association relationship and an association relationship between the beam measurement result and a measurement resource.

Step D-3: When the first device is a network side device and the second device is a terminal, the first device receives the first association relationship sent by the second device.

When one beam measurement result corresponds to a specific measurement resource, the beam measurement result corresponds to a virtual identifier corresponding to the measurement resource. Therefore, in step D-2, the first association relationship can be obtained based on the second association relationship and the association relationship between the beam measurement result and the measurement resource.

It should be noted herein that, when the first device is a terminal and the second device is a network side device, or when the first device is a network side device and the second device is a terminal, the first device may obtain the first association relationship according to the process described in steps D-1 and D-2. When the first device is a network side device and the second device is a terminal, the first device may obtain the first association relationship according to the process described in step D-3.

In addition, when the first device is a terminal and the second device is a network side device, or when the first device is a network side device and the second device is a terminal, the second device may send the second association relationship to the first device.

In some implementations, step A-2 “the first device obtains the beam prediction result of the beam for prediction by using an AI unit based on the beam measurement result, the target association relationship, and the target list includes step E-1 or step E-2.

Step E-1: The first device divides the virtual identifiers in the target list into n batches, inputs the beam measurement result, the target association relationship, and a virtual identifier included in an i^{th} batch into the AI unit for the AI unit to perform inference to output a beam prediction result corresponding to the virtual identifier included in the i^{th} batch, and determines beam prediction results corresponding to the virtual identifiers included in 1^{st} to n^{th} batches as the beam prediction result of the beam for prediction, where i is an integer from 1 to n, n is an integer greater than or equal to 1, and each batch includes at least one virtual identifier.

Step E-2: The first device inputs the beam measurement result and the target association relationship into the AI unit for the AI unit to perform inference to output beam prediction results corresponding to a target universal set, and selects the beam prediction result of the beam for prediction from the beam prediction results corresponding to the target universal set based on the target list, where the target universal set includes virtual identifiers obtained by mapping second information by using the target processing method, and the second information includes related information of beams of a plurality of second devices.

The plurality of second devices (that is, the second devices corresponding to the target universal set) in step E-2 are devices, for example, base stations of a plurality of types or terminals of a plurality of models, that potentially require beam prediction.

Herein, an example in which the target association relationship is the second association relationship is used to describe steps E-1 and E-2 as follows.

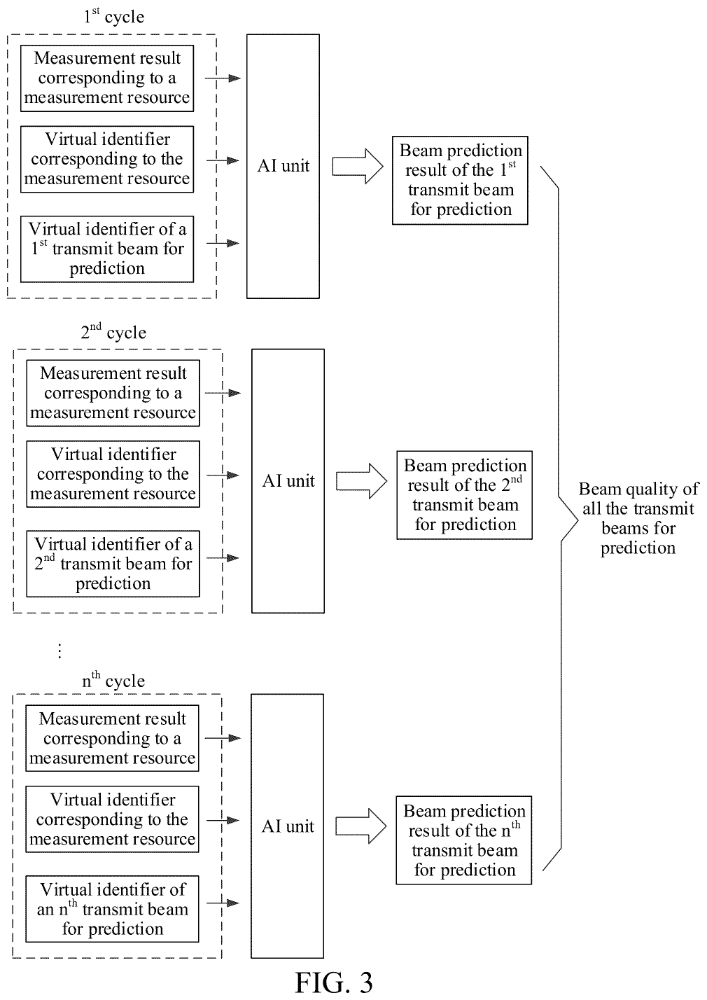

For step E-1, for example, when the first device is a terminal and the second device is a network side device, if each virtual identifier in the target list is used as one batch, as shown in FIG. 3, the AI unit first enters a 1^{st} cycle (that is, running for the first time). To be specific, a beam measurement result corresponding to a measurement resource, a virtual identifier corresponding to the measurement resource (that is, the second association relationship), and a virtual identifier of a 1^{st} transmit beam for prediction are input into the AI unit, so that a beam prediction result of the 1^{st} transmit beam for prediction can be output. Then, the AI unit enters a 2^{nd} cycle (that is, running for the second time). To be specific, a beam measurement result corresponding to a measurement resource, a virtual identifier corresponding to the measurement resource, and a virtual identifier of a 2^{nd} transmit beam for prediction are input into the AI unit, so that a beam prediction result of the 2^{nd} transmit beam for prediction can be output. The process is cyclically performed in this way, until the AI unit enters an n^{th} cycle (that is, running for the n^{th} time), that is, completes a prediction process for a last transmit beam for prediction, to finally obtain beam quality of all transmit beams for prediction.

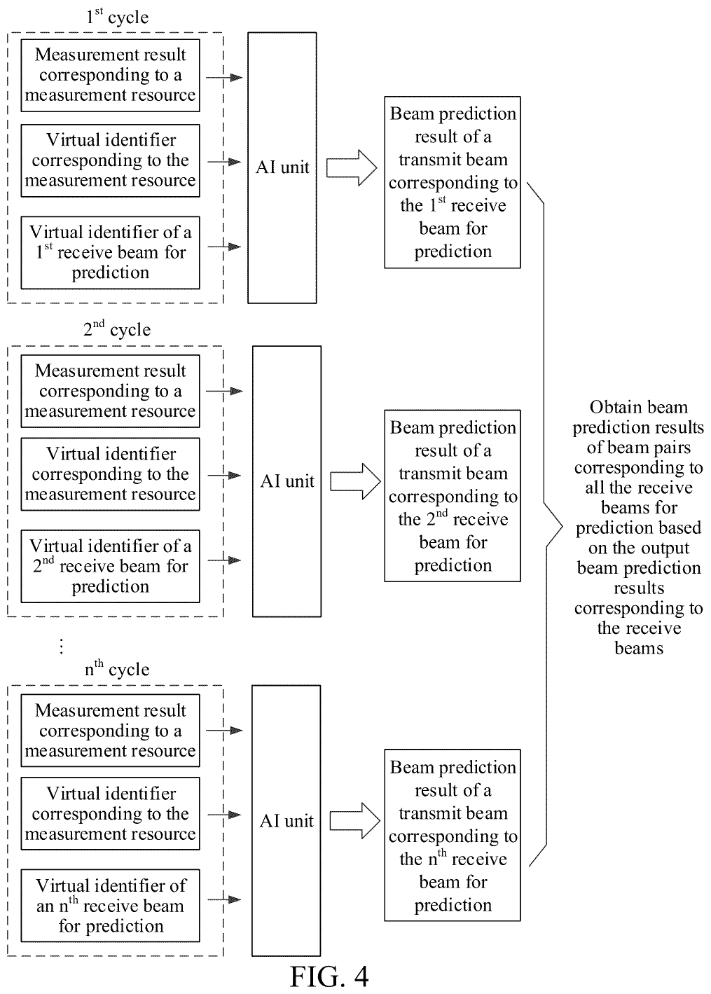

In some implementations, for example, when the first device is a network side device and the second device is a terminal, if each virtual identifier in the target list is used as one batch, as shown in FIG. 4, the AI unit first enters a 1^{st} cycle (that is, running for the first time). To be specific, a beam measurement result corresponding to a measurement resource, a virtual identifier corresponding to the measurement resource (that is, the second association relationship), and a virtual identifier of a 1^{st} receive beam for prediction are input into the AI unit, so that a beam prediction result of a transmit beam corresponding to the 1^{st} receive beam for prediction (that is, a transmit beam that can form a beam pair with the 1^{st} receive beam for prediction) can be output. Then, the AI unit enters a 2^{nd} cycle (that is, running for the second time). To be specific, a beam measurement result corresponding to a measurement resource, a virtual identifier corresponding to the measurement resource, and a virtual identifier of a 2^{nd} receive beam for prediction are input into the AI unit, so that a beam prediction result of a transmit beam corresponding to the 2^{nd} receive beam for prediction can be output. This process is cyclically performed in this way, until the AI unit enters an n^{th} cycle (that is, running for the n^{th} time), that is, completes a prediction process for a last receive beam for prediction, to output a beam prediction result of a transmit beam corresponding to the last receive beam for prediction. In this way, based on the output results of the AI unit in the cycles, the network side device can finally obtain beam prediction results of beam pairs corresponding to all receive beams for prediction.

For step E-2, for example, when the first device is a terminal and the second device is a network side device, the terminal inputs a beam measurement result corresponding to a measurement resource, and a virtual identifier corresponding to the measurement resource (that is, the second association relationship) into the AI unit, so that beam prediction results corresponding to virtual identifiers of transmit beams of base stations of a plurality of models can be output, and then, selects, from these beam prediction results, a beam prediction result corresponding to a virtual identifier included in the target list (that is, selects, from these beam prediction results, a beam prediction result corresponding to a virtual identifier of a transmit beam of a network side device (that is, a network side device currently participating in the beam prediction) currently serving the terminal). For example, the transmit beams of the base stations of the plurality of models include 1024 beam directions, and beam directions of the base station currently participating in the beam prediction are 64 beam directions. In this case, the AI unit outputs the 1024 beam directions, and the 64 beam directions of the base station currently participating in the beam prediction may be selected from the 1024 beam directions.

In some implementations, for example, when the first device is a network side device and the second device is a terminal, the terminal inputs a beam measurement result corresponding to a measurement resource, and a virtual identifier corresponding to the measurement resource (that is, the second association relationship) into the AI unit, so that beam pair prediction results corresponding to virtual identifiers of receive beams of terminals of a plurality of models can be output, and then, selects, from these beam prediction results, a beam pair prediction result corresponding to a virtual identifier included in the target list (that is, selects, from these beam prediction results, a receive/transmit beam pair prediction result corresponding to a virtual identifier of a receive beam of a terminal currently participating in the beam prediction).

It should be noted herein that the beam measurement result is usually a beam measurement result corresponding to a beam pair. When the first device is a terminal, the second device is a network side device, and the terminal predicts a transmit beam of the network side device, there is a particular assumed relationship between a receive beam and a transmit beam. For example, it is assumed that the terminal uses a fixed receive beam when measuring beam quality, or each transmit beam corresponds to a particular receive beam for receiving. Therefore, in step E-1 and step E-2, the second association relationship input into the AI unit may include only an association relationship between a measurement resource and a virtual identifier of a transmit beam.

When the first device is a terminal, the second device is a network side device, and the terminal predicts a receive/transmit beam pair, if there is no particular correspondence between a transmit beam and a receive beam, in step E-1 and step E-2, the second association relationship input into the AI unit may include both an association relationship between a measurement resource and a virtual identifier of a transmit beam and an association relationship between a measurement resource and a virtual identifier of a receive beam. However, when the first device is a network side device and the second device is a terminal, that is, when the network side device predicts a receive/transmit beam pair, if there is no particular correspondence between a transmit beam and a receive beam, in step E-1 and step E-2, the second association relationship input into the AI unit may include both an association relationship between a measurement resource and a virtual identifier of a transmit beam and an association relationship between a measurement resource and a virtual identifier of a receive beam.

It should be further noted that, when the target association relationship is the first association relationship, related explanations for steps E-1 and E-2 are the same as explanations used when the target association relationship is the second association relationship. Details are not described herein again.

In some implementations, the method further includes:

Step F-1: The first device receives a first target content sent by the second device,

The first target content includes at least one of a plurality of candidate association relationships, a plurality of candidate target identifiers, and a plurality of candidate target lists, and the candidate association relationship includes an association relationship between the measurement resource and a plurality of virtual identifiers.

The second association relationship is one of the plurality of candidate association relationships.

The target identifier determined by the first device is one of the plurality of candidate target identifiers.

The target list sent by the second device is one of the plurality of candidate target lists.

It can be learned that the second device may send at least one of a plurality of candidate association relationships, a plurality of candidate target identifiers, and a plurality of candidate target lists to the first device in advance, and then, the second device indicates the first device to use which one of the plurality of candidate association relationships, which one of the plurality of candidate target identifiers, and which one of the plurality of candidate target lists.

The plurality of candidate association relationships, the plurality of candidate target identifiers, and the plurality of candidate target lists may be respectively associated with different scenarios (for example, AI functions or AI characteristics) or associated with a same scenario. To be specific, different candidate association relationships may correspond to different scenarios, or different candidate association relationships may correspond to a same scenario; different candidate target identifiers may correspond to different scenarios, or different candidate target identifiers may correspond to a same scenario; and different candidate target lists may correspond to different scenarios, or different candidate target lists may correspond to a same scenario.

It should be noted that the first device may be notified of, by using a method in which at least one of a target identifier and a virtual identifier is associated with a measurement resource, at least one of a target identifier and a virtual identifier used by the second device.

As shown in Table 1 to Table 3, a CSI-RS resource is associated with different target lists in advance, and a target list currently used is notified to the first device by the second device in a dynamic mode for current measurement and inference.

Virtual identifiers obtained by using different processing methods may be the same, or may be different. Therefore, when target identifiers associated with a measurement resource are different, virtual identifiers associated with the measurement resource may be the same (as shown in Table 1 below). In some implementations, when target identifiers associated with a measurement resource are different, virtual identifiers associated with the measurement resource may also be different (as shown in Table 2 below).

If different beam related information is processed by using a same method, different virtual identifiers may be obtained. Therefore, when target identifiers associated with a measurement resource are the same, virtual identifiers associated with the measurement resource may be different (as shown in Table 3).

TABLE 1
Target identifiers are different and virtual identifiers are the same

| | CSI resource association | | CSI resource association | |
|---|---|---|---|---|
| | relationship 1 | | relationship 2 | |
| CSI-RS | Target | Virtual | Target | Virtual |
| resource | identifier | identifier | identifier | identifier |
| 1 | 1 | 1 | 3 | 1 |
| 2 | 1 | 3 | 3 | 3 |
| 3 | 1 | 5 | 3 | 5 |
| 4 | 1 | 7 | 3 | 7 |
| 5 | 1 | 9 | 3 | 9 |

TABLE 2
Target identifiers are different and virtual identifiers are different

| | CSI resource association | | CSI resource association | |
|---|---|---|---|---|
| | relationship 1 | | relationship 2 | |
| CSI-RS | Target | Virtual | Target | Virtual |
| resource | identifier | identifier | identifier | identifier |
| 1 | 1 | 1 | 3 | 2 |
| 2 | 1 | 3 | 3 | 4 |
| 3 | 1 | 5 | 3 | 6 |
| 4 | 1 | 7 | 3 | 8 |
| 5 | 1 | 9 | 3 | 10 |

TABLE 3
Target identifiers are the same and virtual identifiers are different

| | CSI resource association | | CSI resource association | |
|---|---|---|---|---|
| | relationship 1 | | relationship 2 | |
| CSI-RS | Target | Virtual | Target | Virtual |
| resource | identifier | identifier | identifier | identifier |
| 1 | 1 | 1 | 1 | 2 |
| 2 | 1 | 3 | 1 | 4 |
| 3 | 1 | 5 | 1 | 6 |
| 4 | 1 | 7 | 1 | 8 |
| 5 | 1 | 9 | 1 | 10 |

In some implementations, the first target content is carried in at least one of:
item G-1: channel state information reference signal resource configuration information CSI-RS ResourceConfig;
item G-2: channel state information reference signal resource setting information CSI-RS resource setting;
item G-3: channel state information report configuration information CSI-ReportConfig;
item G-4: channel state information measurement configuration information CSI-MeasConfig;
item G-5: measurement configuration information MeasConfig;
item G-6: a first newly added message; and
item G-7: capability information of the second device.

It can be learned that, when the second device is a network side device, and the first device is a terminal, the second device may add at least one of the plurality of candidate association relationships, the plurality of candidate target identifiers, and the plurality of candidate target lists to at least one of the foregoing items G-1 to G-6, and send the at least one of the plurality of candidate association relationships, the plurality of candidate target identifiers, and the plurality of candidate target lists to the first device. When the second device is a terminal, and the first device is a network device, the second device may add at least one of the plurality of candidate target identifiers or the plurality of candidate target lists to at least one of the foregoing items G-6 and G-7, and send the at least one of the plurality of candidate target identifiers or the plurality of candidate target lists to the first device.

For example, for the candidate association relationship, a same measurement resource may be configured with two virtual identifiers in a CSI-RS resource configuration (that is, CSI-RS ResourceConfig) or a CSI-RS report configuration (that is, CSI-ReportConfig): When an AI characteristic or an AI function is spatial domain prediction, the measurement resource corresponds to one virtual identifier. When an AI characteristic or an AI function is time domain prediction, the measurement resource corresponds to another virtual identifier.

In some implementations, a second target content is carried in at least one of:
item H-1: CSI-RS ResourceConfig;
item H-2: CSI-RS resource setting;
item H-3: CSI-ReportConfig;
item H-4: CSI-MeasConfig; item H-5: MeasConfig;
item H-6: a second newly added message;
item H-7: capability information of the second device;
item H-8: a Media Access Control Control Element (MAC CE); and
item H-9: Downlink Control Information (DCI).

The second target content includes at least one of:
item I-1: a first indication, where the first indication is used for indicating index information of the second association relationship in the plurality of candidate association relationships included in the first target content;
item I-2: a second indication, where the second indication is used for indicating index information of the target identifier determined by the first device in the plurality of candidate target identifiers included in the first target content; and
item I-3: a third indication, where the third indication is used for indicating index information of the target list sent by the second device in the plurality of candidate target lists included in the first target content.

In some implementations,
the second target content includes at least one of:
item J-1: the second association relationship;
item J-2: the target identifier determined by the first device; and
item J-3: the target list sent by the second device.

Herein, items I-1 to I-3 belong to implicit indications, and items J-1 to J-3 belong to explicit indications. It can be learned that, in this embodiment of this application, the second target content may be explicitly indicated or the second target content may be implicitly indicated in at least one of the foregoing items H-1 to H-9.

Compared with the foregoing items H-1 to H-7, the foregoing items H-8 and H-9 belong to dynamic indications. It can be learned that the second device may send the first target content to the first device in advance, and then dynamically indicate the first device to use which content in the first target content (that is, implicitly indicate the second target content); or the second device sends information to the first device, and explicitly indicates the second target content.

In addition, when the first device is a terminal and the second device is a network side device, the second device carries the first target content in at least one of the foregoing items G-1 to G-6, and sends the first target content to the first device. Then, the second device carries the second target content (at least one of I-1 to I-3) in at least one of the foregoing items H-8 and H-9, and sends the second target content to the first device; or the second device adds the second target content (at least one of items J-1 to J-3) to at least one of the foregoing items H-1 to H-5, and sends the second target content to the first device.

When the first device is a network side device and the second device is a terminal, the second device adds the first target content to at least one of the foregoing items G-6 and G-7, and sends the first target content to the first device. Then, the second device sends the second target content (at least one of I-1 to I-3) to the first device by using a trigger event; or the second device carries the second target content (at least one of items J-1 to J-3) in at least one of the foregoing items H-6 and H-7, and sends the second target content to the first device.

In some implementations, when the second device is a terminal, the second target content is sent when the second device satisfies a preconfigured reporting trigger condition.

The reporting trigger condition herein may be sent by the first device, or may be specified by a protocol, or may be configured on a network side. For example, a MAC CE may be used by the base station to configure an event reporting trigger condition for the terminal, and when the terminal satisfies the reporting trigger condition, the terminal sends the second target content to the base station.

In some implementations, the method further includes:
When the first device is a terminal and the second device is a network side device, the first device reports capability information of the first device to the second device.

The capability information of the first device includes at least one of:
item K-1: a quantity of beams that the first device is capable of measuring within a first predetermined time (used as a basis for configuring the measurement resource by the network side device);
item K-2: a quantity of predicted beams that the AI unit is capable of outputting within a second preset time;
item K-3: at least one first value supported by the AI unit, where the first value indicates an output size of the AI unit; and
item K-4: at least one second value or a maximum second value supported by the AI unit, where the second value indicates a quantity of cycles performed by the AI unit within the second preset time.

The item K-1 indicates that the terminal may report, to the network side device, the quantity of beams that the terminal is capable of measuring within the first predetermined time.

In the item K-2, the quantity of predicted beams that the AI unit is capable of outputting within the second preset time is used for indicating a maximum quantity of beams that the AI unit is capable of predicting within the second preset time.

In the item K-3, the first value is a quantity of virtual identifiers included in each batch described above; and the quantity of predicted beams that the AI unit is capable of outputting within the second preset time may be represented by using a product of the first value and the second value.

In some implementations, a product of the first value that the first device selects to use and the second value that the first device selects to use is greater than or equal to a quantity of the virtual identifiers included in the target list. (To be specific, when the first device respectively supports a plurality of first values and a maximum supportable second value, after the first device receives the target list sent by the second device, the first device may select to use a first value and a second value whose product is greater than the quantity of the virtual identifiers included in the target list. For example, the plurality of first values are “8, 16, and 32,” the maximum supportable second value is “4,” and the quantity of the virtual identifiers included in the received target list is 92. In this case, the first device may select the first value of 32 and the second value of 3).

In some implementations,
a quantity of the virtual identifiers included in the target list is a product of a value in a first candidate set and a value in a second candidate set, where the first candidate set includes at least one first value supported by the first device, and the second candidate set includes at least one second value supported by the first device. (For example, values included in the first candidate set are “8, 16, and 32,” and values included in the second candidate set are “2, and 4.” In this case, the quantity of the virtual identifiers included in the target list may be one of six finite values: “8*2, 16*2, 32*2, 16*2, 16*4, and 32*4”).

In some implementations, when the AI unit is trained, or when inference is performed using the AI unit, or when the AI unit is monitored, the target identifier is associated with a measurement resource.

When the first device is a terminal and the second device is a network side device, the association relationship between the target identifier and the measurement resource is carried in at least one of:
item L-1: CSI-RS ResourceConfig;
item L-2: CSI-RS resource setting;
item L-3: CSI-ReportConfig;
item L-4: CSI-MeasConfig; and
item L-5: MeasConfig;

When the first device is a network side device and the second device is a terminal, the association relationship between the target identifier and the measurement resource is carried in at least one of:

item M-1: Uplink Control Information (UCI); and

item M-2: radio resource control RRC information.

It can be learned that the terminal may add the association relationship between the target identifier and the measurement resource to at least one of the foregoing items L-1 to L-5, and send the association relationship between the target identifier and the measurement resource to the network side device, or the network side device may add the association relationship between the target identifier and the measurement resource to at least one of the foregoing items M-1 and M-2, and send the association relationship between the target identifier and the measurement resource to the terminal.

In some implementations, the method further includes:

The first device sends a target result to the second device, where the target result includes beam prediction results corresponding to at least a subset of the virtual identifiers in the target list.

Herein, when the first device is a terminal and the second device is a network side device, the terminal may report, to the network side device, the beam prediction results corresponding to at least the subset of the virtual identifiers in the target list. In some implementations, when the first device is a network side device and the second device is a terminal, the network side device may send, to the terminal, the beam prediction results corresponding to at least the subset of the virtual identifiers in the target list.

In some implementations, the method further includes:

The first device sends a fourth indication to the second device, where the fourth indication is used for indicating location information of the virtual identifiers corresponding to the target result in the target list.

To be specific, when the first device is a terminal and the second device is a network side device, when reporting the beam prediction results corresponding to at least the subset of the virtual identifiers in the target list to the network side device, the terminal may further indicate sequential positions of the virtual identifiers that are in the target list and that respectively correspond to the beam prediction results. When the first device is a network side device and the second device is a terminal, when sending the beam prediction results corresponding to at least the subset of the virtual identifiers in the target list to the terminal, the network side device may further indicate sequential positions of the virtual identifiers that are in the target list and that respectively correspond to the beam prediction results.

In some implementations, that the first device sends a target result to the second device includes:

When the first device is a terminal and the second device is a network side device, the first device sends UCI to the second device, where the UCI carries the target result.

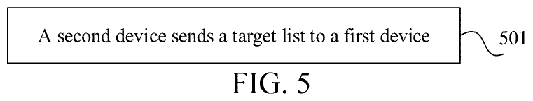

According to a second aspect, FIG. 5 is a flowchart of a beam prediction method according to an embodiment of this application. The method may include the following step 501.

Step 501: A second device sends a target list to a first device.

The target list includes virtual identifiers used for indicating related information of beams for prediction.

In some implementations, before step 501 “a second device sends a target list to a first device”, the method further includes:

The second device receives request information sent by the first device, where the request information is used by the first device to request the second device for the target list.

In addition, after receiving the target list, the first device obtains a beam prediction result of the beam for prediction based on at least one beam measurement result and the target list.

It may be learned from step 501 that, in this embodiment of this application, the first device can receive the target list sent by the second device, to obtain the beam prediction result of the beam for prediction based on the at least one beam measurement result and the target list. The target list includes the virtual identifiers used for indicating the related information of the beams for prediction. It may be learned that, in this embodiment of this application, the virtual identifiers used for indicating the related information of the beams for prediction instead of the related information of the beams for prediction is directly transmitted between the first device and the second device. In this way, the beam measurement result and the virtual identifiers used for indicating the related information of the beams for prediction can be combined to implement more accurate beam prediction without exposing sensitive information of the beam. Therefore, the beam prediction method in this embodiment of this application resolves a problem of exposing the sensitive information of the beam.

In some implementations, before step 501 “a second device sends a target list to a first device”, the method further includes:

The second device maps first information by using a target processing method to obtain virtual identifiers, and generates the target list based on the obtained virtual identifiers,

The first information includes beam related information of the second device.

It should be noted herein that all the virtual identifiers obtained by mapping the first information may form the target list, or a subset of the virtual identifiers obtained by mapping the first information may form the target list.

In some implementations, the method further includes:

The second device sends at least one of the following to the first device:
a target identifier, where the target identifier is used for indicating the target processing method;
at least one beam measurement result;
a first association relationship, where the first association relationship includes an association relationship between the beam measurement result and a virtual identifier; and
a second association relationship, where the second association relationship includes an association relationship between a measurement resource used for beam measurement and a virtual identifier.

Herein, for a process executed by the first device based on the received target identifier, the first association relationship, or the second association relationship, refer to the foregoing descriptions. Details are not described herein again.

In some implementations, the method further includes:

The second device sends a first target content to the first device.

The first target content includes at least one of a plurality of candidate association relationships, a plurality of candidate target identifiers, and a plurality of candidate target lists, and the candidate association relationship includes an association relationship between the measurement resource and a plurality of virtual identifiers.

The second association relationship is one of the plurality of candidate association relationships;
the target identifier sent by the second device is one of the plurality of candidate target identifiers; and
the target list sent by the second device is one of the plurality of candidate target lists.

In some implementations, the first target content is carried in at least one of:
item G-1: channel state information reference signal resource configuration information CSI-RS ResourceConfig;
item G-2: channel state information reference signal resource setting information CSI-RS resource setting;
item G-3: channel state information report configuration information CSI-ReportConfig;
item G-4: channel state information measurement configuration information CSI-MeasConfig;
item G-5: measurement configuration information MeasConfig;
item G-6: a first newly added message; and
item G-7: capability information of the second device.

In some implementations, a second target content is carried in at least one of:
item H-1: CSI-RS ResourceConfig;
item H-2: CSI-RS resource setting;
item H-3: CSI-ReportConfig;
item H-4: MeasConfig;
item H-5: CSI-MeasConfig;
item H-6: a second newly added message;
item H-7: capability information of the second device;
item H-8: a MAC CE; and
item-H.9: DCI.

The second target content includes at least one of:
item I-1: a first indication, where the first indication is used for indicating index information of the second association relationship in the plurality of candidate association relationships included in the first target content;
item I-2: a second indication, where the second indication is used for indicating index information of the target identifier sent by the second device in the plurality of candidate target identifiers included in the first target content; and
item I-3: a third indication, the third indication being used to indicate index information that is of the target list and that is sent by the second device and that is in a plurality of candidate target lists included in the first target content.

In some implementations,
the second target content includes at least one of:
item J-1: the second association relationship;
item J-2: the target identifier sent by the second device; and
item J-3: the target list sent by the second device.

In some implementations, the method further includes:

When the second device is a network side device and the first device is a terminal, the second device receives capability information of the first device sent by the first device.

The capability information of the first device includes at least one of:
item K-1: a quantity of beams that the first device is capable of measuring within a first predetermined time;
item K-2: a quantity of predicted beams that an artificial intelligence AI unit is capable of outputting within a second preset time, where the AI unit is configured to predict a beam prediction result corresponding to a virtual identifier included in the target list;
item K-3: at least one first value supported by the AI unit, where the first value indicates an output size of the AI unit; and
item K-4: at least one second value or a maximum second value supported by the AI unit, where the second value indicates a quantity of cycles performed by the AI unit within the second preset time.

In some implementations, a product of the first value that the first device selects to use and the second value that the first device selects to use is greater than or equal to a quantity of the virtual identifiers included in the target list;
or
a quantity of the virtual identifiers included in the target list is a product of a value in a first candidate set and a value in a second candidate set, where the first candidate set includes at least one first value supported by the first device, and the second candidate set includes at least one second value supported by the first device.

In some implementations, when an AI unit is trained, or when inference is performed using the AI unit, or when the AI unit is monitored, the target identifier is associated with a measurement resource, where the AI unit is configured to predict a beam prediction result corresponding to a virtual identifier included in the target list. The measurement resource includes at least one of:
a channel state information reference signal resource (CSI-RS resource);
a synchronization signal and a PBCH block (Synchronization Signal and PBCH block, SSB); and
a newly added beam measurement resource.

When the first device is a terminal and the second device is a network side device, the association relationship between the target identifier and the measurement resource is carried in at least one of:
item L-1: CSI-RS ResourceConfig;
item L-2: CSI-RS resource setting;
item L-3: CSI-ReportConfig;
item L-4: CSI-MeasConfig; and
item L-5: MeasConfig.

When the first device is a network side device and the second device is a terminal, the association relationship between the target identifier and the measurement resource is carried in at least one of:
item M-1: UCI; and
item M-2: RRC.

In some implementations, the method further includes:

The second device receives a target result sent by the first device, where the target result includes beam prediction results corresponding to at least a subset of the virtual identifiers in the target list.

In some implementations, the method further includes:

The second device receives a fourth indication sent by the first device, where the fourth indication is used for indicating location information of the virtual identifiers corresponding to the target result in the target list.

In some implementations, that the second device receives a target result sent by the first device includes:

When the second device is a network side device and the first device is a terminal, the second device receives UCI sent by the first device, where the UCI carries the target result.

In some implementations, the second target content is sent when the second device satisfies a preconfigured reporting trigger condition.

It should be noted that this embodiment is used as an implementation of the second device corresponding to the embodiment shown in FIG. 2. For a specific implementation, refer to related descriptions of the embodiment shown in FIG. 2 (that is, the beam prediction method in the foregoing first aspect). To avoid repeated descriptions, details are not described in this embodiment again.

In conclusion, a specific implementation of the beam prediction method in this embodiment of this application may be described in any one of the following implementations 1 and 2.

Implementation 1: A base station maps a virtual identifier, and a terminal performs beam prediction.

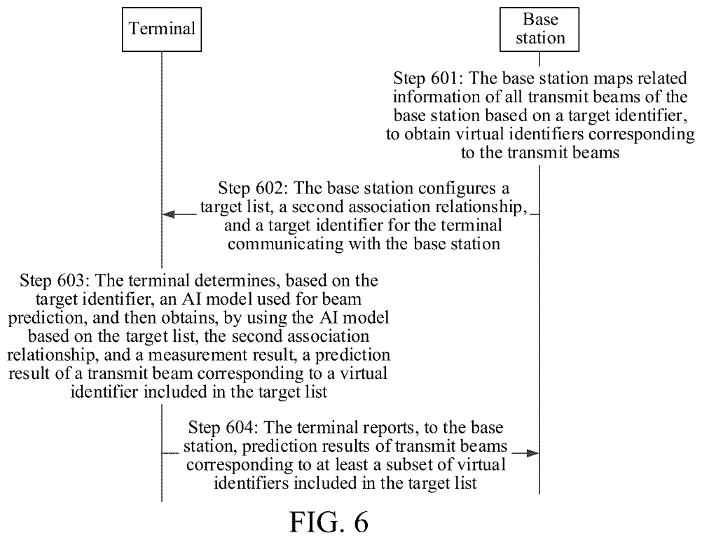

As shown in FIG. 6, the implementation 1 includes the following steps 601 to 604.

Step 601: The base station maps related information of all transmit beams of the base station based on a target identifier, to obtain virtual identifiers corresponding to the transmit beams.

Herein, the target identifier is used for indicating a target processing method, that is, used for indicating a method in which the beam related information is mapped to the virtual identifiers, for example, may be function mapping. The related information of the transmit beam may include a beam direction, a 3 dB bandwidth of the beam, and the like.

Step 602: The base station configures a target list, a second association relationship, and a target identifier for the terminal communicating with the base station.

The target list includes at least a subset of the virtual identifiers obtained in step 601, and the second association relationship includes an association relationship between a measurement resource and a virtual identifier.

In addition, the target list, the second association relationship, and the target identifier may be sent in one piece of signaling, or may be sent in a plurality of pieces of signaling.

In some implementations, the target identifier may be included in the target list.

In some implementations, it may be configured that the target identifier is associated with a CSI-RS resource during model training, model monitoring, or model inference (that is, performing beam prediction by using an AI model), to align mapping methods for the virtual identifiers during the model training, the model monitoring, and the model inference. An association relationship between the target identifier and the CSI-RS resource may be carried in at least one of:
CSI-RS ResourceConfig;
CSI-RS resource setting;
CSI-ReportConfig;
CSI-MeasConfig; and
MeasConfig.

In some implementations, the base station may explicitly configure the target list, the second association relationship, and the target identifier for the terminal. For example, the target list, the second association relationship, and the target identifier may be included in at least one of:
CSI-RS ResourceConfig;
CSI-RS resource setting;
CSI-ReportConfig;
CSI-MeasConfig;
MeasConfig;
a second newly added message;
a MAC CE; and
DCI.

In some implementations, the base station may implicitly configure the target list, the second association relationship, and the target identifier for the terminal. For example, the base station may preconfigure a plurality of candidate target lists for the terminal, and dynamically indicate the terminal to use one of the plurality of candidate target lists. The base station may preconfigure a plurality of candidate association relationships for the terminal (that is, a same measurement resource corresponds to different virtual identifiers), and dynamically indicate the terminal to use one of the plurality of candidate association relationships as the second association relationship. The base station may preconfigure a plurality of candidate target identifiers for the terminal, and then dynamically indicate the terminal to use one of the plurality of candidate target identifiers.

The plurality of candidate target lists preconfigured for the terminal, the plurality of candidate association relationships preconfigured for the terminal, and the plurality of candidate target identifiers preconfigured for the terminal may be included in at least one of:
CSI-RS ResourceConfig;
CSI-RS resource setting;
CSI-ReportConfig;
CSI-MeasConfig;
MeasConfig; and
a second newly added message.

An index used for dynamically indicating the target list used by the terminal in the plurality of candidate target lists, an index used for dynamically indicating the second association relationship used by the terminal in the plurality of candidate association relationships, and an index used for dynamically indicating the target identifier used by the terminal in the plurality of candidate target identifiers may be included in at least one of:
a MAC CE; and
DCI.

Step 603: The terminal determines, based on the target identifier, an AI model used for beam prediction, and then obtains, by using the AI model based on the target list, the second association relationship, and a beam measurement result, a prediction result of a transmit beam corresponding to a virtual identifier included in the target list.

The beam measurement result includes beam quality (for example, L1-RSRP) measured by the terminal.

In some implementations, step 603 of “obtaining, by using the AI model based on the target list, the second association relationship, and a beam measurement result, a prediction result of a transmit beam corresponding to a virtual identifier included in the target list” may be implemented in the following manner 1 or manner 2.

Manner 1: In step 603, the terminal may divide the virtual identifiers in the target list into n batches, and input the beam measurement result, the second association relationship, and a virtual identifier included in an i^{th} batch into the AI unit for the AI unit to perform inference to output a prediction result of a transmit beam corresponding to the virtual identifier included in the i^{th} batch, where i is an integer from 1 to n, n is an integer greater than or equal to 1, and each batch includes at least one virtual identifier.

Manner 2: In step 603, the terminal may input the beam measurement result and the second correlation relationship into the AI unit for the AI unit to perform inference to output prediction results of transmit beams corresponding to virtual identifiers included in a target universal set, and then select the prediction result of the transmit beam corresponding to the virtual identifier included in the target list from the prediction results of the transmit beams corresponding to the virtual identifiers included in the target universal set, where the target universal set includes virtual identifiers obtained by processing related information of transmit beams of base stations of a plurality of models by using the target processing method.

In addition, during training of the AI model, the terminal may generate a data set based on the virtual identifiers of the beams for prediction, the beam measurement result, and third target information, and associate the data set with a target identifier. The third target information includes a virtual identifier corresponding to the beam measurement result or a virtual identifier corresponding to a measurement resource.

Step 604: The terminal reports, to the base station, prediction results of transmit beams corresponding to at least a subset of the virtual identifiers included in the target list.

The terminal may further report a fourth indication to the base station. The fourth indication is used for indicating location information of the virtual identifiers corresponding to the prediction results of the transmit beams reported by the terminal to the base station in the target list. In other words, the fourth indication is used for indicating sequential positions of the virtual identifiers that are in the target list and that respectively correspond to the prediction results of the transmit beams reported by the terminal to the base station.

In some implementations, the terminal may report the prediction results of the transmit beams by using UCI.

In addition, it should be noted that, before step 601, the terminal may further report capability information of the terminal to the base station. The capability information may include at least one of:
a quantity of beams that the terminal is capable of measuring within a first predetermined time;
a quantity of predicted beams that the AI unit is capable of outputting within a second preset time;
at least one first value supported by the AI unit, where the first value indicates an output size of the AI unit (that is, a quantity of virtual identifiers included in each batch in the foregoing manner 1); and
at least one second value or a maximum second value supported by the AI unit, where the second value indicates a quantity of cycles performed by the AI unit within the second preset time.

In this way, a product of the first value that the terminal selects to use in the foregoing manner 1 and the second value that the terminal selects to use is greater than or equal to a quantity of the virtual identifiers included in the target list; or a quantity of the virtual identifiers included in the target list is a product of a value in a first candidate set and a value in a second candidate set, where the first candidate set includes at least one first value supported by the first device, and the second candidate set includes at least one second value supported by the first device.

Implementation 2: A terminal maps a virtual identifier, and a base station performs beam prediction.

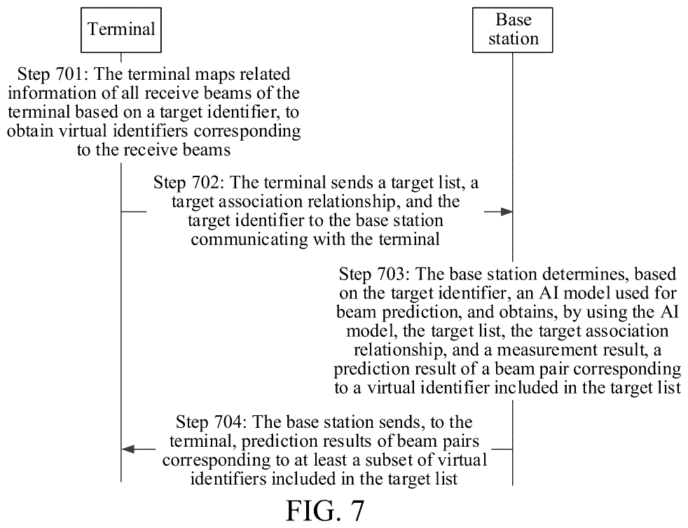

As shown in FIG. 7, the implementation 2 includes the following steps 701 to 704.

Step 701: The terminal maps related information of all receive beams of the terminal based on a target identifier, to obtain virtual identifiers corresponding to the receive beams.

Herein, the target identifier is used for indicating a target processing method, that is, used for indicating a method in which the beam related information is mapped to the virtual identifiers, for example, may be function mapping. The related information of the receive beam may include a beam direction, a 3 dB bandwidth of the beam, and the like.

Step 702: The terminal sends a target list, a target association relationship, and the target identifier to the base station communicating with the terminal.

The target list includes at least a subset of the virtual identifiers obtained in step 701, the target association relationship is a second association relationship or a first association relationship, the second association relationship includes an association relationship between a measurement resource and a virtual identifier, and the first association relationship includes an association relationship between a beam measurement result and a virtual identifier. The beam measurement result herein includes beam quality that can be measured by the terminal.

In addition, the target list, the target association relationship, and the target identifier may be sent in one piece of signaling, or may be sent in a plurality of pieces of signaling.

In some implementations, a MAC CE may be used by the base station to configure an event reporting trigger condition for the terminal. When the terminal satisfies the reporting trigger condition, the terminal sends at least one of the target list, the target association relationship, and the target identifier to the base station. For example, the reporting trigger condition is that the target list is updated. When the target list of the terminal is updated, the terminal reports an updated target list to the base station.

In some implementations, the target identifier may be included in the target list.

In some implementations, the terminal may explicitly send the target list, the second association relationship, and the target identifier to the base station. For example, the target list, the second association relationship, and the target identifier may be included in at least one of:
a second newly added message; and
capability information of the terminal.

In some implementations, the terminal may implicitly send the target list, the second association relationship, and the target identifier to the base station. For example, the terminal may send a plurality of candidate target lists to the base station in advance, to dynamically indicate the base station to use one of the plurality of candidate target lists. The terminal may send a plurality of candidate association relationships to the base station in advance (that is, a same measurement resource corresponds to different virtual identifiers), to dynamically indicate the base station to use one of the plurality of candidate association relationships as the second association relationship. The terminal may send a plurality of candidate target identifiers to the base station in advance, to dynamically indicate the base station to use one of the plurality of candidate target identifiers.

The plurality of candidate target lists sent to the base station in advance, the plurality of candidate association relationships sent to the base station in advance, and the plurality of candidate target identifiers sent to the base station in advance may be included in at least one of:
a second newly added message; and
capability information of the terminal. An index used for dynamically indicating the target list used by the base station in the plurality of candidate target lists, an index used for dynamically indicating the second association relationship used by the base station in the plurality of candidate association relationships, and an index used for dynamically indicating the target identifier used by the base station in the plurality of candidate target identifiers may be included in reporting of a trigger event. For example, a MAC CE may be used by the base station to configure an event reporting trigger condition. When the target list of the second device is updated, reporting of an event is triggered, to notify the base station.

Step 703: The base station determines, based on the target identifier, an AI model used for beam prediction, and obtains, by using the AI model based on the target list, the target association relationship, and a beam measurement result, a prediction result of a beam pair corresponding to a virtual identifier included in the target list.

In step 702, if the target association relationship sent by the terminal to the base station is the second association relationship, in step 703, the base station may obtain the first association relationship between the beam measurement result and the virtual identifier based on the second association relationship and the association relationship between the measurement resource and the beam measurement result, and then obtain, by using the AI model based on the target list, the first association relationship, and the beam measurement result, the prediction result of the beam pair corresponding to the virtual identifier included in the target list; or the base station may obtain, by using the AI model based on the target list, the second association relationship, and the beam measurement result, the prediction result of the beam pair corresponding to the virtual identifier included in the target list.

In step 702, if the target association relationship sent by the terminal to the base station is the first association relationship, the base station may obtain, by using the AI model based on the target list, the first association relationship, and the beam measurement result, the prediction result of the beam pair corresponding to the virtual identifier included in the target list.

Herein, that the base station obtains, by using the AI model based on the target list, the target association relationship (that is, the first association relationship or the second association relationship), and the beam measurement result, the prediction result of the beam pair corresponding to the virtual identifier included in the target list may be specifically implemented in the following manner 1 or manner 2.

Manner 1: The base station may divide the virtual identifiers in the target list into n batches, and input the beam measurement result, the target association relationship, and a virtual identifier included in an i^{th} batch into the AI model for the AI unit to perform inference to output a prediction result of a beam pair corresponding to the virtual identifier included in the i^{th} batch, where i is an integer from 1 to n, n is an integer greater than or equal to 1, and each batch includes at least one virtual identifier.

Manner 2: The base station may input the beam measurement result and the target association relationship into the AI unit for the AI unit to perform inference to output a prediction result of a beam pair corresponding to a virtual identifier included in a target universal set, and then select the prediction result of the beam pair corresponding to the virtual identifier included in the target list from prediction results of beam pairs corresponding to virtual identifiers included in the target universal set. Herein, the target universal set includes the virtual identifiers obtained by processing related information of receive beams of terminals of a plurality of models by using a target processing method.

In addition, the base station may generate, during training of the AI model, a data set based on the virtual identifiers of the beams for prediction, the beam measurement result, and third target information, and associate the data set with a target identifier. The third target information includes a virtual identifier corresponding to the beam measurement result or a virtual identifier corresponding to a measurement resource.

Step 704: The base station sends, to the terminal, prediction results of beam pairs corresponding to at least a subset of the virtual identifiers included in the target list.

The base station may further send a fourth indication to the terminal. The fourth indication is used for indicating location information of the virtual identifiers corresponding to the prediction results of the beam pairs sent by the base station to the terminal in the target list. That is, the fourth indication indicates sequential positions of the virtual identifiers that are in the target list and that respectively correspond to the prediction results of the beam pairs sent by the base station to the terminal.

In conclusion, in this embodiment of this application, a target list including virtual identifiers of beams for prediction is sent to the terminal through the base station, to indicate information about beams for prediction of base stations with different antenna or beam configurations, so that prediction information of a corresponding beam can be obtained for a specific type of base station during model inference. In some implementations, a target list including virtual identifiers of beams for prediction is sent to a base station through a terminal, to indicate information about beams for prediction of terminals with different antenna or beam configurations, so that prediction information of a corresponding beam can be obtained for a specific type of terminal during model inference. Further, adaptability of an AI unit to different base stations or terminals is improved.

The beam prediction method provided in embodiments of this application may be performed by a beam prediction apparatus. In embodiments of this application, the beam prediction apparatus provided in embodiments of this application is described by using an example in which the beam prediction apparatus performs the beam prediction method.

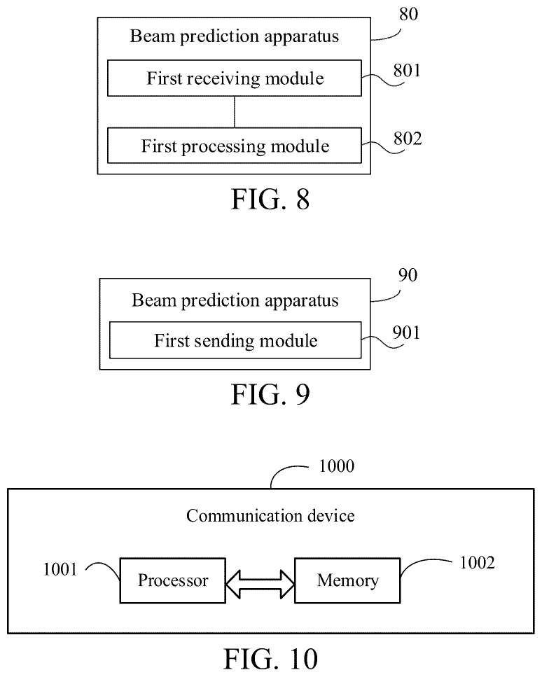

According to a third aspect, an embodiment of this application provides a beam prediction apparatus, applied to a first device. As shown in FIG. 8, the beam prediction apparatus 80 may include the following modules:
a first receiving module 801, configured to receive a target list sent by a second device, where the target list includes virtual identifiers used for indicating related information of beams for prediction; and
a first processing module 802, configured to obtain a beam prediction result of the beam for prediction based on at least one beam measurement result and the target list.

In some implementations, the first processing module 802 includes:
a first obtaining sub-module, configured to obtain a target association relationship, where the target association relationship includes at least one of a first association relationship and a second association relationship, the first association relationship includes an association relationship between the beam measurement result and a virtual identifier, and the second association relationship includes an association relationship between a measurement resource used for beam measurement and a virtual identifier; and
a first processing sub-module, configured to obtain the beam prediction result of the beam for prediction by using an artificial intelligence AI unit based on the beam measurement result, the target association relationship, and the target list.

In some implementations, the apparatus further includes:
an identifier determining module, configured to determine a target identifier,
where the target identifier is used for indicating a target processing method, the virtual identifiers are obtained by mapping first information by using the target processing method, and the first information includes beam related information of the second device; and
the AI unit is associated with the target identifier.

In some implementations, that the obtaining sub-module obtains the first association relationship is specifically to:
receive the second association relationship sent by the second device; and
obtain the first association relationship according to the second association relationship and an association relationship between the beam measurement result and a measurement resource;
or
when the first device is a network side device and the second device is a terminal, receive the first association relationship sent by the second device.

In some implementations, the first processing sub-module is specifically configured to:
divide the virtual identifiers in the target list into n batches, input the beam measurement result, the target association relationship, and a virtual identifier included in an i^{th} batch into the AI unit for the AI unit to perform inference to output a beam prediction result corresponding to the virtual identifier included in the i^{th} batch, and determine beam prediction results corresponding to the virtual identifiers included in 1^{st} to n^{th} batches as the beam prediction result of the beam for prediction, where i is an integer from 1 to n, n is an integer greater than or equal to 1, and each batch includes at least one virtual identifier;
or

input the beam measurement result and the target association relationship into the AI unit for the AI unit to perform inference to output beam prediction results corresponding to a target universal set, and select the beam prediction result of the beam for prediction from the beam prediction results corresponding to the target universal set based on the target list, where the target universal set includes virtual identifiers obtained by mapping second information by using the target processing method, and the second information includes related information of beams of a plurality of second devices.

In some implementations, the apparatus further includes:
a second receiving module, configured to receive a first target content sent by the second device,
where the first target content includes at least one of a plurality of candidate association relationships, a plurality of candidate target identifiers, and a plurality of candidate target lists, and the candidate association relationship includes an association relationship between the measurement resource and a plurality of virtual identifiers;
the second association relationship is one of the plurality of candidate association relationships;
the target identifier determined by the identifier determining module is one of the plurality of candidate target identifiers; and
the target list sent by the second device is one of the plurality of candidate target lists.

In some implementations, the first target content is carried in at least one of:
channel state information reference signal resource configuration information CSI-RS ResourceConfig;
channel state information reference signal resource setting information CSI-RS resource setting;
channel state information report configuration information CSI-ReportConfig;
channel state information measurement configuration information CSI-MeasConfig;
measurement configuration information MeasConfig;
a first newly added message; and
capability information of the second device.

In some implementations, a second target content is carried in at least one of:
CSI-RS ResourceConfig;
CSI-RS resource setting;
CSI-ReportConfig;
CSI-MeasConfig;
MeasConfig;
a second newly added message;
capability information of the second device;
a media access control control element MAC CE; and
downlink control information DCI,
where the second target content includes at least one of:
a first indication, where the first indication is used for indicating index information of the second association relationship in the plurality of candidate association relationships included in the first target content;
a second indication, where the second indication is used for indicating index information of the target identifier determined by the identifier determining module in the plurality of candidate target identifiers included in the first target content; and
a third indication, where the third indication is used for indicating index information of the target list sent by the second device in the plurality of candidate target lists included in the first target content;
or
the second target content includes at least one of:
the second association relationship;
the target identifier determined by the identifier determining module; and
the target list sent by the second device.

In some implementations, the apparatus further includes:
a first reporting module, configured to: when the first device is a terminal and the second device is a network side device, report capability information of the first device to the second device,
where the capability information of the first device includes at least one of:
a quantity of beams that the first device is capable of measuring within a first predetermined time;
a quantity of predicted beams that the AI unit is capable of outputting within a second preset time;
at least one first value supported by the AI unit, where the first value indicates an output size of the AI unit; and
at least one second value or a maximum second value supported by the AI unit, where the second value indicates a quantity of cycles performed by the AI unit within the second preset time.

In some implementations, a product of the first value that the first device selects to use and the second value that the first device selects to use is greater than or equal to a quantity of the virtual identifiers included in the target list;
or
a quantity of the virtual identifiers included in the target list is a product of a value in a first candidate set and a value in a second candidate set, where the first candidate set includes at least one first value supported by the first device, and the second candidate set includes at least one second value supported by the first device.

In some implementations, when the AI unit is trained, or when inference is performed using the AI unit, or when the AI unit is monitored, the target identifier is associated with a measurement resource;
when the first device is a terminal and the second device is a network side device, the association relationship between the target identifier and the measurement resource is carried in at least one of:
CSI-RS ResourceConfig;
CSI-RS resource setting;
CSI-ReportConfig;
CSI-MeasConfig; and
MeasConfig; and
when the first device is a network side device and the second device is a terminal, the association relationship between the target identifier and the measurement resource is carried in at least one of:

uplink control information UCI; and

radio resource control RRC information.

In some implementations, the apparatus further includes:
a second sending module, configured to send a target result to the second device, where the target result includes beam prediction results corresponding to at least a subset of the virtual identifiers in the target list.

In some implementations, the apparatus further includes:
a third sending module, configured to send a fourth indication to the second device, where the fourth indication is used for indicating location information of the virtual identifiers corresponding to the target result in the target list.

In some implementations, the second sending module is specifically configured to:
when the first device is a terminal and the second device is a network side device, send UCI to the second device, where the UCI carries the target result.

In some implementations, the second target content is sent when the second device satisfies a preconfigured reporting trigger condition.

In some implementations, the apparatus further includes:
an association module, configured to generate, during training of the AI unit, a data set based on the virtual identifiers of the beams for prediction, the beam measurement result, and third target information, and associate the data set with a target identifier,
where the third target information includes a virtual identifier corresponding to the beam measurement result or a virtual identifier corresponding to the measurement resource.

In some implementations, the apparatus further includes:
a fourth sending module, configured to send request information to the second device, where the request information is used by the first device to request the second device for the target list.

The beam prediction apparatus in this embodiment of this application may be an electronic device, for example, an electronic device having an operating system, or a component in an electronic device, such as an integrated circuit or a chip. The electronic device may be a terminal or a network side device. For example, the terminal may include, but is not limited to, the type of the terminal 11 listed above, and the network side device may include, but is not limited to, the type of the network side device 12 listed above. This is not specifically limited in embodiments of this application.

The beam prediction apparatus provided in this embodiment of this application can implement all processes implemented by the method embodiment in FIG. 2 and the same technical effects are achieved. To avoid repetition, details are not described herein again.

According to a fourth aspect, an embodiment of this application provides a beam prediction apparatus, applied to a second device. As shown in FIG. 9, the beam prediction apparatus 90 may include the following modules:
a first sending module 901, configured to send a target list to a first device, where the target list includes virtual identifiers used for indicating related information of beams for prediction.

In some implementations, the apparatus further includes:
a mapping module, configured to map first information by using a target processing method to obtain virtual identifiers, and generate the target list based on the obtained virtual identifiers,
where the first information includes beam related information of the second device.

In some implementations, the apparatus further includes:
a fifth sending module, configured to send at least one of the following to the first device:
a target identifier, where the target identifier is used for indicating the target processing method;
at least one beam measurement result;
a first association relationship, where the first association relationship includes an association relationship between the beam measurement result and a virtual identifier; and
a second association relationship, where the second association relationship includes an association relationship between a measurement resource used for beam measurement and a virtual identifier.

In some implementations, the apparatus further includes:
a sixth sending module, configured to send a first target content to the first device,
where the first target content includes at least one of a plurality of candidate association relationships, a plurality of candidate target identifiers, and a plurality of candidate target lists, and the candidate association relationship includes an association relationship between the measurement resource and a plurality of virtual identifiers;
the second association relationship is one of the plurality of candidate association relationships;
the target identifier sent by the fifth sending module is one of the plurality of candidate target identifiers; and
the target list sent by the first sending module 901 is one of the plurality of candidate target lists.

In some implementations, the first target content is carried in at least one of:
channel state information reference signal resource configuration information CSI-RS ResourceConfig;
channel state information reference signal resource setting information CSI-RS resource setting;
channel state information report configuration information CSI-ReportConfig;
channel state information measurement configuration information CSI-MeasConfig;
measurement configuration information MeasConfig;
a first newly added message; and
capability information of the second device.

In some implementations, a second target content is carried in at least one of:
CSI-RS ResourceConfig;
CSI-RS resource setting;
CSI-ReportConfig;
CSI-MeasConfig;
MeasConfig;
a second newly added message;
capability information of the second device;
a media access control control element MAC CE; and
downlink control information DCI,
where the second target content includes at least one of:
a first indication, where the first indication is used for indicating index information of the second association relationship in the plurality of candidate association relationships included in the first target content;
a second indication, where the second indication is used for indicating index information of the target identifier sent by the fifth sending module in the plurality of candidate target identifiers included in the first target content; and
a third indication, where the third indication is used for indicating index information of the target list sent by the first sending module 901 in the plurality of candidate target lists included in the first target content;
or
the second target content includes at least one of:
the second association relationship;
the target identifier sent by the fifth sending module; and
the target list sent by the first sending module 901.

In some implementations, the apparatus further includes:
a third receiving module, configured to: when the second device is a network side device and the first device is a terminal, receive capability information of the first device sent by the first device,
where the capability information of the first device includes at least one of:
a quantity of beams that the first device is capable of measuring within a first predetermined time;
a quantity of predicted beams that an artificial intelligence AI unit is capable of outputting within a second preset time, where the AI unit is configured to predict a beam prediction result corresponding to a virtual identifier included in the target list;
at least one first value supported by the AI unit, where the first value indicates an output size of the AI unit; and
at least one second value or a maximum second value supported by the AI unit, where the second value indicates a quantity of cycles performed by the AI unit within the second preset time.

In some implementations, a product of the first value that the first device selects to use and the second value that the first device selects to use is greater than or equal to a quantity of the virtual identifiers included in the target list;
or
a quantity of the virtual identifiers included in the target list is a product of a value in a first candidate set and a value in a second candidate set, where the first candidate set includes at least one first value supported by the first device, and the second candidate set includes at least one second value supported by the first device.

In some implementations, when an AI unit is trained, or when inference is performed using the AI unit, or when the AI unit is monitored, the target identifier is associated with a measurement resource, where the AI unit is configured to predict a beam prediction result corresponding to a virtual identifier included in the target list;
when the first device is a terminal and the second device is a network side device, the association relationship between the target identifier and the measurement resource is carried in at least one of:
CSI-RS ResourceConfig;
CSI-RS resource setting;
CSI-ReportConfig;
CSI-MeasConfig; and MeasConfig; and
when the first device is a network side device and the second device is a terminal, the association relationship between the target identifier and the measurement resource is carried in at least one of:
uplink control information UCI; and
radio resource control RRC information.

In some implementations, the apparatus further includes:
a fourth receiving module, configured to receive a target result sent by the first device, where the target result includes beam prediction results corresponding to at least a subset of the virtual identifiers in the target list.

In some implementations, the apparatus further includes:
a fifth receiving module, configured to receive a fourth indication sent by the first device, where the fourth indication is used for indicating location information of the virtual identifiers corresponding to the target result in the target list.

In some implementations, the fourth receiving module is specifically configured to:
when the second device is a network side device and the first device is a terminal, receive UCI sent by the first device, where the UCI carries the target result.

In some implementations, the second target content is sent when the second device satisfies a preconfigured reporting trigger condition.

In some implementations, the apparatus further includes:
a sixth receiving module, configured to receive request information sent by the first device, where the request information is used by the first device to request the second device for the target list.

The beam prediction apparatus in this embodiment of this application may be an electronic device, for example, an electronic device having an operating system, or a component in an electronic device, such as an integrated circuit or a chip. The electronic device may be a terminal or a network side device. For example, the terminal may include, but is not limited to, the type of the terminal 11 listed above, and the network side device may include, but is not limited to, the type of the network side device 12 listed above. This is not specifically limited in embodiments of this application.

The beam prediction apparatus provided in this embodiment of this application can implement all processes implemented by the method embodiment in FIG. 5 and the same technical effects are achieved. To avoid repetition, details are not described herein again.

As shown in FIG. 10, an embodiment of this application further provides a communication device 1000, including a processor 1001 and a memory 1002. The memory 1002 stores a program or instructions runnable on the processor 1001. When the program or the instructions are executed by the processor 1001, all steps of embodiments of the beam prediction method described in the first aspect or the second aspect are implemented, and same technical effects can be achieved. To avoid repetition, details are not described herein again.

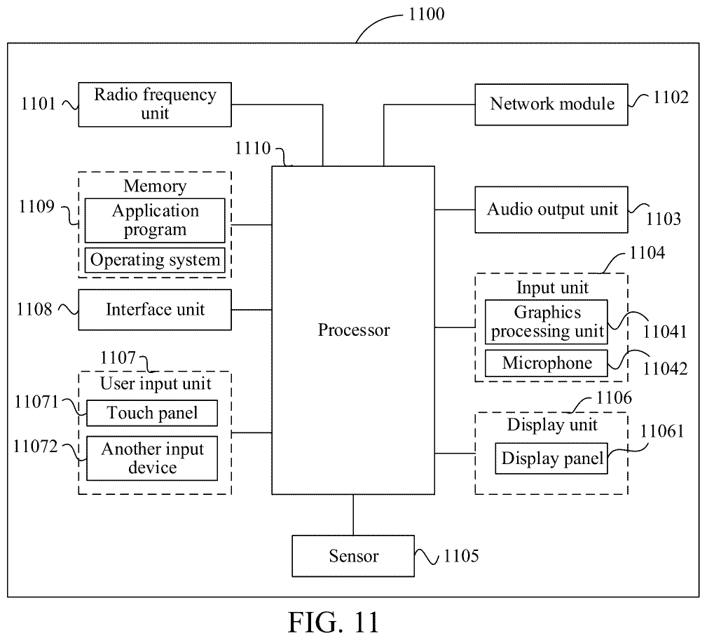

An embodiment of this application further provides a terminal, including a processor and a communication interface. The communication interface is coupled to the processor, and the processor is configured to run a program or instructions, to implement the steps in the method embodiment show in FIG. 11. This terminal embodiment corresponds to the foregoing terminal side method embodiment. Each implementation process and implementation of the foregoing method embodiment are applicable to the terminal embodiment, and same technical effects can be achieved. FIG. 11 is a diagram of a hardware structure of a terminal according to an embodiment of this application.

The terminal 1100 includes, but is not limited to, at least some components such as a radio frequency unit 1101, a network module 1102, an audio output unit 1103, an input unit 1104, a sensor 1105, a display unit 1106, a user input unit 1107, an interface unit 1108, a memory 1109, and a processor 1110.

It may be understood by a person skilled in the art that the terminal device 1100 may further include a power supply (such as a battery) for supplying power to various components. The power supply may be logically connected to the processor 1110 through a power management system, to achieve charging, discharging, power consumption management and other functions through the power management system. The terminal structure shown in FIG. 11 constitutes no limitation on the terminal, and the terminal may include more or fewer components than those shown in the figure, or some components are combined, or different component arrangements are used. Details are not described herein again.

It should be understood that in this embodiment of this application, the input unit 1104 may include a graphics processing unit (Graphics Processing Unit, GPU) 11041 and a microphone 11042. The graphics processing unit 11041 processes image data of a still picture or a video that is obtained by an image acquisition apparatus (for example, a camera) by using a video acquisition method or an image acquisition method. The display unit 1106 may include a display panel 11061. The display panel 11061 may be configured by using a liquid crystal display, an organic light-emitting diode, or the like. The user input unit 1107 includes at least one of a touch panel 11071 and another input device 11072. The touch panel 11071 is also referred to as a touchscreen. The touch panel 11071 may include two parts: a touch detection apparatus and a touch controller. The another input device 11072 may include, but is not limited to, a physical keyboard, a functional key (such as a volume control key or a switch key), a track ball, a mouse, and a joystick. Details are not described herein again.

In this embodiment of this application, the radio frequency unit 1101 receives downlink data from a network side device and then transmits the data to the processor 1110 for processing. In addition, the radio frequency unit 1101 may send uplink data to the network side device. Usually, the radio frequency unit 1101 includes, but is not limited to, an antenna, an amplifier, a transceiver, a coupler, a low noise amplifier, a duplexer, and the like.

The memory 1109 may be configured to store a software program or instructions and various data. The memory 1109 may mainly include a first storage area for storing a program or instructions and a second storage area for storing data. The first storage area may store an operating system, an application program or instructions required for at least one function (for example, a sound playback function or an image display function), and the like. Moreover, the memory 1109 may include a volatile memory or a non-volatile memory. The non-volatile memory may be a Read-Only Memory (ROM), a Programmable Read-Only Memory (PROM), an Erasable Programmable Read-Only Memory (EPROM), an Electrically Erasable Programmable Read-Only Memory (EEPROM), or a flash memory. The volatile memory may be a Random Access Memory (RAM), a Static Random Access Memory (SRAM), a Dynamic Random Access Memory (DRAM), a Synchronous Dynamic Random Access Memory (SDRAM), a Double Data Rate Synchronous Dynamic Random Access Memory (DDR SDRAM), an Enhanced Synchronous Dynamic Random Access Memory (ESDRAM), a Synchlink Dynamic Random Access Memory (SLDRAM), or a Direct Rambus Random Access Memory (DR RAM). The memory 1109 in this embodiment of this application includes, but not limited to, these memories and any other suitable type of memory.

The processor 1110 may include one or more processing units. In some implementations, the processor 1110 integrates an application processor and a modem processor. The application processor mainly processes operations involving an operating system, a user interface, an application program, and the like. The modem processor mainly processes a wireless communication signal, and is, for example, a baseband processor. It may be understood that the modem processor may not be integrated into the processor 1110.

According to a first aspect, when the terminal 1100 is used as a first device, the radio frequency unit 1101 is configured to receive a target list sent by a second device, where the target list includes virtual identifiers used for indicating related information of beams for prediction; and

The processor 1110 is configured to obtain a beam prediction result of the beam for prediction based on at least one beam measurement result and the target list.

In some implementations, that the processor 1110 obtains a beam prediction result of the beam for prediction based on at least one beam measurement result and the target list includes:
obtaining a target association relationship, where the target association relationship includes at least one of a first association relationship and a second association relationship, the first association relationship includes an association relationship between the beam measurement result and a virtual identifier, and the second association relationship includes an association relationship between a measurement resource used for beam measurement and a virtual identifier; and
obtaining the beam prediction result of the beam for prediction by using an artificial intelligence AI unit based on the beam measurement result, the target association relationship, and the target list.

In some implementations, the processor 1110 is further configured to determine a target identifier,
where the target identifier is used for indicating a target processing method, the virtual identifiers are obtained by mapping first information by using the target processing method, and the first information includes beam related information of the second device; and
the AI unit is associated with the target identifier.

In some implementations, that the processor 1110 obtains the first association relationship includes:
The radio frequency unit 1101 receives the second association relationship sent by the second device; and
obtains the first association relationship based on the second association relationship and an association relationship between the beam measurement result and a measurement resource.

In some implementations, that the processor 1110 obtains the beam prediction result of the beam for prediction by using an AI unit based on the beam measurement result, the target association relationship, and the target list includes:

dividing the virtual identifiers in the target list into n batches, inputting the beam measurement result, the target association relationship, and a virtual identifier included in an i^{th} batch into the AI unit for the AI unit to perform inference to output a beam prediction result corresponding to the virtual identifier included in the i^{th} batch, and determining beam prediction results corresponding to the virtual identifiers included in 1^{st} to n^{th} batches as the beam prediction result of the beam for prediction, where i is an integer from 1 to n, n is an integer greater than or equal to 1, and each batch includes at least one virtual identifier;
or
inputting the beam measurement result and the target association relationship into the AI unit for the AI unit to perform inference to output beam prediction results corresponding to a target universal set, and selecting the beam prediction result of the beam for prediction from the beam prediction results corresponding to the target universal set based on the target list, where the target universal set includes virtual identifiers obtained by mapping second information by using the target processing method, and the second information includes related information of beams of a plurality of second devices.

In some implementations, the radio frequency unit 1101 is further configured to:
receive a first target content sent by the second device,
where the first target content includes at least one of a plurality of candidate association relationships, a plurality of candidate target identifiers, and a plurality of candidate target lists, and the candidate association relationship includes an association relationship between the measurement resource and a plurality of virtual identifiers;
the second association relationship is one of the plurality of candidate association relationships;
the target identifier determined by the processor 1110 is one of the plurality of candidate target identifiers; and
the target list sent by the second device is one of the plurality of candidate target lists.

In some implementations, the first target content is carried in at least one of:
channel state information reference signal resource configuration information CSI-RS ResourceConfig;
channel state information reference signal resource setting information CSI-RS resource setting;
channel state information report configuration information CSI-ReportConfig;
channel state information measurement configuration information CSI-MeasConfig;
measurement configuration information MeasConfig;
a first newly added message; and
capability information of the second device.

In some implementations, a second target content is carried in at least one of:
CSI-RS ResourceConfig;
CSI-RS resource setting;
CSI-ReportConfig;
CSI-MeasConfig;
MeasConfig;
a second newly added message;
capability information of the second device;
a media access control control element MAC CE; and
downlink control information DCI,
where the second target content includes at least one of:
a first indication, where the first indication is used for indicating index information of the second association relationship in the plurality of candidate association relationships included in the first target content;
a second indication, where the second indication is used for indicating index information of the target identifier determined by the processor 1110 in the plurality of candidate target identifiers included in the first target content; and
a third indication, where the third indication is used for indicating index information of the target list sent by the second device in the plurality of candidate target lists included in the first target content;
or
the second target content includes at least one of:
the second association relationship;
the target identifier determined by the processor 1110; and
the target list sent by the second device.

In some implementations, the radio frequency unit 1101 is further configured to:
when the second device is a network side device, report capability information of the first device to the second device,
where the capability information of the first device includes at least one of:
a quantity of beams that the first device is capable of measuring within a first predetermined time;
a quantity of predicted beams that the AI unit is capable of outputting within a second preset time;
at least one first value supported by the AI unit, where the first value indicates an output size of the AI unit; and
at least one second value or a maximum second value supported by the AI unit, where the second value indicates a quantity of cycles performed by the AI unit within the second preset time.

In some implementations, a product of the first value that the first device selects to use and the second value that the first device selects to use is greater than or equal to a quantity of the virtual identifiers included in the target list;
or
a quantity of the virtual identifiers included in the target list is a product of a value in a first candidate set and a value in a second candidate set, where the first candidate set includes at least one first value supported by the first device, and the second candidate set includes at least one second value supported by the first device.

In some implementations, when the AI unit is trained, or when inference is performed using the AI unit, or when the AI unit is monitored, the target identifier is associated with a measurement resource; and
when the first device is a terminal and the second device is a network side device, the association relationship between the target identifier and the measurement resource is carried in at least one of:
CSI-RS ResourceConfig;
CSI-RS resource setting;
CSI-ReportConfig;
CSI-MeasConfig; and
MeasConfig.

In some implementations, the radio frequency unit 1101 is further configured to:
send a target result to the second device, where the target result includes beam prediction results corresponding to at least a subset of the virtual identifiers in the target list.

In some implementations, the radio frequency unit 1101 is further configured to:
send a fourth indication to the second device, where the fourth indication is used for indicating location information of the virtual identifiers corresponding to the target result in the target list.

In some implementations, that the radio frequency unit 1101 sends a target result to the second device includes:
when the second device is a network side device, sending UCI to the second device, where the UCI carries the target result.

In some implementations, the second target content is sent when the second device satisfies a preconfigured reporting trigger condition.

In some implementations, the processor 1110 is further configured to:
generate, during training of the AI unit, a data set based on the virtual identifiers of the beams for prediction, the beam measurement result, and third target information, and associating the data set with a target identifier,
where the third target information includes a virtual identifier corresponding to the beam measurement result or a virtual identifier corresponding to the measurement resource.

In some implementations, before receiving the target list sent by the second device, the radio frequency unit 1101 is further configured to:
send request information to the second device, where the request information is used by the first device to request the second device for the target list.

According to a second aspect, when the terminal 1100 is used as the second device, the radio frequency unit 1101 is configured to: send a target list to a first device, where the target list includes virtual identifiers used for indicating related information of beams for prediction.

In some implementations, before that the radio frequency unit 1101 sends a target list to a first device, the processor 1110 is further configured to:
map first information by using a target processing method to obtain virtual identifiers, and generate the target list based on the obtained virtual identifiers,
where the first information includes beam related information of the second device.

In some implementations, the radio frequency unit 1101 is further configured to:
send at least one of the following to the first device:
a target identifier, where the target identifier is used for indicating the target processing method;
at least one beam measurement result;
a first association relationship, where the first association relationship includes an association relationship between the beam measurement result and a virtual identifier; and
a second association relationship, where the second association relationship includes an association relationship between a measurement resource used for beam measurement and a virtual identifier.

In some implementations, the radio frequency unit 1101 is further configured to:
send a first target content to the first device,
where the first target content includes at least one of a plurality of candidate association relationships, a plurality of candidate target identifiers, and a plurality of candidate target lists, and the candidate association relationship includes an association relationship between the measurement resource and a plurality of virtual identifiers;
the second association relationship is one of the plurality of candidate association relationships;
the target identifier sent by the radio frequency unit 1101 is one of the plurality of candidate target identifiers; and
the target list sent by the radio frequency unit 1101 is one of the plurality of candidate target lists.

In some implementations, the first target content is carried in at least one of:
channel state information reference signal resource configuration information CSI-RS ResourceConfig;
channel state information reference signal resource setting information CSI-RS resource setting;
channel state information report configuration information CSI-ReportConfig;
channel state information measurement configuration information CSI-MeasConfig;
measurement configuration information MeasConfig;
a first newly added message; and
capability information of the second device.

In some implementations, a second target content is carried in at least one of:
CSI-RS ResourceConfig;
CSI-RS resource setting;
CSI-ReportConfig;
CSI-MeasConfig;
MeasConfig;
a second newly added message;
capability information of the second device;
a media access control control element MAC CE; and
downlink control information DCI,
where the second target content includes at least one of:
a first indication, where the first indication is used for indicating index information of the second association relationship in the plurality of candidate association relationships included in the first target content;
a second indication, where the second indication is used for indicating index information of the target identifier sent by the radio frequency unit 1101 in the plurality of candidate target identifiers included in the first target content; and
a third indication, where the third indication is used for indicating index information of the target list sent by the radio frequency unit 1101 in the plurality of candidate target lists included in the first target content;
or
the second target content includes at least one of:
the second association relationship;
the target identifier sent by the radio frequency unit 1101; and
the target list sent by the radio frequency unit 1101.

In some implementations, when an AI unit is trained, or when inference is performed using the AI unit, or when the AI unit is monitored, the target identifier is associated with a measurement resource, where the AI unit is configured to predict a beam prediction result corresponding to a virtual identifier included in the target list.

When the first device is a network side device and the second device is a terminal, the association relationship between the target identifier and the measurement resource is carried in at least one of:
uplink control information UCI; and
radio resource control RRC information.

In some implementations, the radio frequency unit 1101 is further configured to:
receive a target result sent by the first device, where the target result includes beam prediction results corresponding to at least a subset of the virtual identifiers in the target list.

In some implementations, the radio frequency unit 1101 is further configured to:
receive a fourth indication sent by the first device, where the fourth indication is used for indicating location information of the virtual identifiers corresponding to the target result in the target list.

In some implementations, the second target content is sent when the second device satisfies a preconfigured reporting trigger condition.

In some implementations, before sending the target list to the first device, the radio frequency unit 1101 is further configured to:
receive request information sent by the first device, where the request information is used by the first device to request the second device for the target list.

It may be understood that, an implementation process of each implementation mentioned in this embodiment may refer to the related descriptions of the beam prediction method in the method embodiments, and the same or corresponding technical effects are achieved. To avoid repetition, details are not described herein again.

An embodiment of this application further provides a network side device, including a processor and a communication interface. The communication interface is coupled to the processor, and the processor is configured to run a program or instructions, to implement the steps in the method embodiment shown in FIG. 2 or FIG. 5. This network side device embodiment corresponds to the foregoing network side device method embodiment. Each implementation process and implementation of the foregoing method embodiment are applicable to the network side device embodiment, and same technical effects can be achieved.

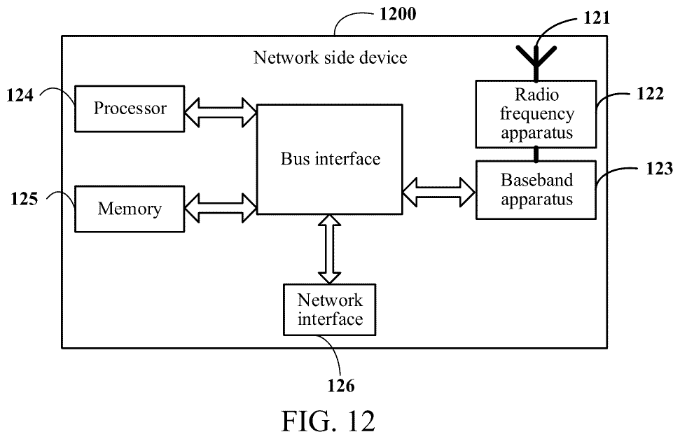

An embodiment of this application further provides a network side device. As shown in FIG. 12, the network side device 1200 includes: an antenna 121, a radio frequency apparatus 122, a baseband apparatus 123, a processor 124, and a memory 125. The antenna 121 is connected to the radio frequency apparatus 122. In an uplink direction, the radio frequency apparatus 122 receives information through the antenna 121, and sends the received information to the baseband apparatus 123 for processing. In a downlink direction, the baseband apparatus 123 processes to-be-sent information, and sends processed to-be-sent information to the radio frequency apparatus 122. The radio frequency apparatus 122 processes the received information, and then sends processed information through the antenna 121.

The method performed by the network side device in the foregoing embodiments may be implemented in the baseband apparatus 123. The baseband apparatus 123 includes a baseband processor.

The baseband apparatus 123 may include, for example, at least one baseband board. A plurality of chips are disposed on the baseband board. As shown in FIG. 12, one of the chips is, for example, the baseband processor, and is connected to the memory 125 through a bus interface to invoke a program in the memory 125, to perform an operation of a network device shown in the foregoing method embodiments.

The network side device may further include a network interface 126. The interface is, for example, a Common Public Radio Interface (CPRI).

In some implementations, the network side device 1200 in this embodiment of this application further includes: instructions or a program stored in the memory 125 and executable on the processor 124. The processor 124 invokes the instructions or the program in the memory 125 to perform the method performed by each module shown in FIG. 2 or FIG. 5, and same technical effects are achieved. To avoid repetition, details are not described herein again.

An embodiment of this application further provides a readable storage medium. The readable storage medium stores a program or instructions. When the program or instructions are executed by a processor, the processes in embodiments of the beam prediction method described in the first aspect or the second aspect are implemented, and same technical effects can be achieved. To avoid repetition, details are not described herein again.

The processor is a processor in the terminal described in the foregoing embodiments. The readable storage medium includes a computer-readable storage medium, such as a computer read-only memory ROM, a random access memory RAM, a magnetic disk, or an optical disk. In some examples, the readable storage medium may be a non-transitory readable storage medium.

An embodiment of this application further provides a chip. The chip includes a processor and a communication interface. The communication interface is coupled to the processor. The processor is configured to run a program or instructions to implement the processes in embodiments of the beam prediction method described in the first aspect or the second aspect, and same technical effects can be achieved. To avoid repetition, details are not described herein again.

It should be understood that the chip mentioned in this embodiment of this application may also be referred to as a system level chip, a system chip, a chip system, a system-on-a-chip, or the like.

An embodiment of this application further provides a computer program/program product, the computer program/program product is stored in a storage medium, and the computer program/program product is executed by at least one processor to implement the processes in embodiments of the beam prediction method described in the first aspect or the second aspect, and same technical effects can be achieved. To avoid repetition, details are not described herein again.

An embodiment of this application further provides a beam prediction system, including: a first device and a second device, where the first device may be configured to perform the steps of the beam prediction method described in the first aspect, and the second device may be configured to perform the steps of the beam prediction method described in the second aspect.

It should be noted that in this application, the terms “include”, “have” or any other variants are intended to encompass non-exclusive inclusion, such that a process, a method, an article, or an apparatus including a series of elements not only include those elements, but also includes other elements not listed explicitly or includes inherent elements for the process, the method, the article, or the apparatus. Without any further limitation, an element defined by the phrase “including one” does not exclude existence of other same elements in the process, the method, the article, or the apparatus that includes the elements. In addition, it should be noted that the scope of the methods and apparatus in embodiments of this application is not limited to performing functions in the order shown or discussed, and may also include performing the functions in a substantially simultaneous manner or in reverse order depending on the functions involved, for example, the described method may be performed in a different order than that described, and various steps may also be added, omitted, or combined. In addition, features described with reference to some examples may be combined in other examples.

From the above detailed description of the embodiments, a person skilled in the art may clearly understand that the methods in the foregoing embodiments may be implemented by using a computer software product and a necessary general-purpose hardware platform, or certainly, by using hardware. The computer software product is stored in a storage medium (such as a ROM, a RAM, a magnetic disk, an optical disc, etc.), and includes several instructions for instructing a terminal or a network side device, or the like) to execute the methods described in embodiments of this application.

Embodiments of this application are described above with reference to the accompanying drawings. However, this application is not limited to the specific implementations described above, and the specific implementations described above are merely exemplary and not limitative. Inspired by this application, a person of ordinary skill in the art may obtain various implementations without departing from the principle of this application and the protection scope of the claims, and such implementations shall all fall within the protection scope of this application.

What is claimed is:

1. A beam prediction method, performed by a first device, wherein the beam prediction method comprises:
receiving a target list sent by a second device, wherein the target list comprises virtual identifiers used for indicating related information of a beam for prediction; and
obtaining a beam prediction result of the beam for prediction based on at least one beam measurement result and the target list.

2. The beam prediction method according to claim 1, wherein the obtaining a beam prediction result of the beam for prediction based on at least one beam measurement result and the target list comprises:
obtaining a target association relationship, wherein the target association relationship comprises at least one of a first association relationship or a second association relationship, the first association relationship comprises an association relationship between the beam measurement result and a virtual identifier, and the second association relationship comprises an association relationship between a measurement resource used for beam measurement and a virtual identifier; and
obtaining the beam prediction result of the beam for prediction by using an Artificial Intelligence (AI) unit based on the beam measurement result, the target association relationship, and the target list.

3. The beam prediction method according to claim 2, further comprising:
determining a target identifier,
wherein the target identifier is used for indicating a target processing method, the virtual identifiers are obtained by mapping first information by using the target processing method, and the first information comprises beam related information of the second device; and
the AI unit is associated with the target identifier.

4. The beam prediction method according to claim 3, further comprising:
receiving a first target content sent by the second device,
wherein the first target content comprises at least one of a plurality of candidate association relationships, a plurality of candidate target identifiers, or a plurality of candidate target lists, and the candidate association relationship comprises an association relationship between the measurement resource and a plurality of virtual identifiers;
the second association relationship is one of the plurality of candidate association relationships;
the target identifier determined by the first device is one of the plurality of candidate target identifiers; and
the target list sent by the second device is one of the plurality of candidate target lists.

5. The beam prediction method according to claim 4, wherein the first target content is carried in at least one of:
Channel State Information Reference Signal Resource Configuration information (CSI-RS ResourceConfig);
Channel State Information Reference Signal Resource Setting information (CSI-RS Resource Setting);
Channel State Information Report Configuration information (CSI-ReportConfig);
Channel State Information Measurement Configuration information (CSI-MeasConfig);
Measurement Configuration information (MeasConfig);
a first newly added message; or
capability information of the second device.

6. The beam prediction method according to claim 3, wherein when the AI unit is trained, when inference is performed using the AI unit, or when the AI unit is monitored, the target identifier is associated with a measurement resource;
when the first device is a terminal and the second device is a network side device, the association relationship between the target identifier and the measurement resource is carried in at least one of:
CSI-RS ResourceConfig;
CSI-RS Resource Setting;
CSI-ReportConfig;
CSI-MeasConfig; or
MeasConfig,
wherein when the first device is the network side device and the second device is the terminal, the association relationship between the target identifier and the measurement resource is carried in at least one of:
Uplink Control Information (UCI); or
Radio Resource Control (RRC) information.

7. The beam prediction method according to claim 1, further comprising:
sending a target result to the second device, wherein the target result comprises beam prediction results corresponding to at least a subset of the virtual identifiers in the target list.

8. The beam prediction method according to claim 1, wherein the related information of the beam comprises at least one of:
a beam direction;
a 3 dB bandwidth of the beam;
a beam gain;
an antenna radiation pattern; or
an antenna configuration parameter.

9. A first device, comprising:
a memory storing computer-readable instructions; and
a processor coupled to the memory and configured to execute the computer-readable instructions, wherein the computer-readable instructions, when executed by the processor, cause the processor to perform operations comprising:
receiving a target list sent by a second device, wherein the target list comprises virtual identifiers used for indicating related information of a beam for prediction; and
obtaining a beam prediction result of the beam for prediction based on at least one beam measurement result and the target list.

10. The first device according to claim 9, wherein the obtaining a beam prediction result of the beam for prediction based on at least one beam measurement result and the target list comprises:
obtaining a target association relationship, wherein the target association relationship comprises at least one of a first association relationship or a second association relationship, the first association relationship comprises an association relationship between the beam measurement result and a virtual identifier, and the second association relationship comprises an association relationship between a measurement resource used for beam measurement and a virtual identifier; and
obtaining the beam prediction result of the beam for prediction by using an Artificial Intelligence (AI) unit based on the beam measurement result, the target association relationship, and the target list.

11. The first device according to claim 10, wherein the operations further comprise:
determining a target identifier,
wherein the target identifier is used for indicating a target processing method, the virtual identifiers are obtained by mapping first information by using the target processing method, and the first information comprises beam related information of the second device; and
the AI unit is associated with the target identifier.

12. The first device according to claim 11, wherein the operations further comprise:
receiving a first target content sent by the second device,
wherein the first target content comprises at least one of a plurality of candidate association relationships, a plurality of candidate target identifiers, or a plurality of candidate target lists, and the candidate association relationship comprises an association relationship between the measurement resource and a plurality of virtual identifiers;
the second association relationship is one of the plurality of candidate association relationships;
the target identifier determined by the first device is one of the plurality of candidate target identifiers; and
the target list sent by the second device is one of the plurality of candidate target lists.

13. The first device according to claim 12, wherein the first target content is carried in at least one of:
Channel State Information Reference Signal Resource Configuration information (CSI-RS ResourceConfig);
Channel State Information Reference Signal Resource Setting information (CSI-RS Resource Setting);
Channel State Information Report Configuration information (CSI-ReportConfig);
Channel State Information Measurement Configuration information (CSI-MeasConfig);
Measurement Configuration information (MeasConfig);
a first newly added message; or
capability information of the second device.

14. The first device according to claim 11, wherein when the AI unit is trained, when inference is performed using the AI unit, or when the AI unit is monitored, the target identifier is associated with a measurement resource;
when the first device is a terminal and the second device is a network side device, the association relationship between the target identifier and the measurement resource is carried in at least one of:
CSI-RS ResourceConfig;
CSI-RS Resource Setting;
CSI-ReportConfig;
CSI-MeasConfig; or
MeasConfig,
wherein when the first device is the network side device and the second device is the terminal, the association relationship between the target identifier and the measurement resource is carried in at least one of:
Uplink Control Information (UCI); or
Radio Resource Control (RRC) information.

15. The first device according to claim 9, wherein the operations further comprise:
sending a target result to the second device, wherein the target result comprises beam prediction results corresponding to at least a subset of the virtual identifiers in the target list.

16. The first device according to claim 9, wherein the related information of the beam comprises at least one of:
a beam direction;
a 3 dB bandwidth of the beam;
a beam gain;
an antenna radiation pattern; or
an antenna configuration parameter.

17. A beam prediction method, performed by a second device, wherein the beam prediction method comprises:
sending a target list to a first device, wherein the target list comprises virtual identifiers used for indicating related information of a beam for prediction.

18. The beam prediction method according to claim 17, wherein before the sending a target list to a first device, the beam prediction method further comprises:
mapping first information by using a target processing method to obtain virtual identifiers, and generating the target list based on the obtained virtual identifiers,
wherein the first information comprises beam related information of the second device.

19. The beam prediction method according to claim 18, further comprising:
sending at least one of the following to the first device:
a target identifier, wherein the target identifier is used for indicating the target processing method;
at least one beam measurement result;
a first association relationship, wherein the first association relationship comprises an association relationship between the beam measurement result and a virtual identifier; or
a second association relationship, wherein the second association relationship comprises an association relationship between a measurement resource used for beam measurement and the virtual identifier.

20. The beam prediction method according to claim 17, wherein the related information of the beam comprises at least one of:
a beam direction;
a 3 dB bandwidth of the beam;
a beam gain;
an antenna radiation pattern; or
an antenna configuration parameter.
